(19) United States
(12) Patent Application Publication
(10) Pub. No.: US 2026/0366360 A1
(43) Pub. Date: Nov. 19, 2026

(54) MULTI-PANE GLASS OR INSULATING GLASS VISION ELEMENT

(71) Applicant: SEEN AG, St. Gallen (CH)

(72) Inventor: Rouven SEIDLER, Herzogenbuchsee (CH)

(21) Appl. No.: 19/142,662

(22) PCT Filed: Dec. 19, 2023
(86) PCT No.: PCT/EP2023/086724

§ 371 Date: Jun. 24, 2025

(30) Foreign Application Priority Data
Dec. 29, 2022 (DE) 10 2022 134 997.7

(51) Int. Cl. E06B 3/67; A01M 29/08; B44F 1/06

(52) U.S. Cl. CPC E06B 3/6715; A01M 29/08; B44F 1/06

(57) ABSTRACT

A multiglazed glass vision element including at least a first glass pane and a second glass pane, and at least one pane interspace between the first glass pane and the second glass pane that spaces them apart, where the glass panes with the at least one pane interspace are kept spaced apart by a spacer structure. A multitude of sequins are arranged in the multiglazed vision element to achieve a visual appearance. A sequin has a light-absorbing surface and a light-reflecting surface, and in an installed state of the multiglazed glass vision element, the light-absorbing surface faces a building interior and the light-reflecting surface faces a building exterior. The multitude of sequins are spaced apart from one another such that the multiglazed glass vision element appears transparent when viewed from a side of the light-absorbing surface and less transparent when viewed from a side of the light-reflecting surface.

### CROSS REFERENCE TO RELATED APPLICATIONS

This application is a U.S. National Phase application under 35 U.S.C. § 371 of International Application No. PCT/EP 2023/086724, filed on Dec. 19, 2023, and claims benefit to German Patent Application No. DE 10 2022 134 997.7, filed on Dec. 29, 2022. The International Application was published in German on Jul. 4, 2024 as WO 2024/141346 A1 under PCT Article 21(2).

### FIELD

Embodiments of the invention relate to a multiglazed glass vision element, in particular insulation glass vision element, or in particular a more broadly functional multiglazed glass vision element or insulation glass vision element. The multiglazed glass vision element or insulation glass vision element is preferably designed with a further visual functionality, in particular with a bird protection functionality. Embodiments of the invention also relate to a window element and/or facade element for an installed state in a facade or in an interior configuration of a building space.

Embodiments of the invention also relate to a production method for the multiglazed insulation glass vision element and to the use of the multiglazed glass vision element or insulation glass vision element, in particular as a window element and/or facade element, for a broader functional effect, preferably with a visual bird protection functionality.

### BACKGROUND

The prior art already discloses transparent glasses or presentation materials that are transparent from one side. However, a preferred effect is one-sided transparency, the basis of which is firstly that these glasses or display glass panels have a layer structure having a single-sidedly light-absorbing coating with a multitude of openings. Viewed from this light-absorbing side, the insert has a transparent appearance; the other side is reflective and hence prevents transparency from that side. Visual functions, and in particular visual functions with a broader functional effect, are becoming increasingly important; in particular, glass visible to birds should be available as a solution that is classified as highly effective. However, several constraints in this regard likewise have to be taken into account.

US 2009/0169795 A1 describes layer structures of a similar kind, in the form of a dot pattern film or weave, in particular as metallic weave, which could then be coated on one side with light-absorbing material. Also known in addition are light-absorbing black weaves made of monofilaments with a single-sided metallic coating or printed glasses with a reflective coating.

It is true that printed glass or the like has been the preferred solution in the glass industry to date. However, printed glass with a visual function or with a broader functional effect, in particular as a bird protection solution, always requires printing on an external position (in FIG. 1A, view (b), labelled glass surface Pos1), i.e. on the outside of the glass pane. This means that this solution is subject to higher soiling, and the question of warranty obligations arises. Printing also requires quite a complex production process including tempering of the glass pane—this is energy-intensive and can be associated with a deterioration of the glass quality caused by “roller waves.”

In addition, a print that can be classified as a highly effective protection against bird strike requires a certain printed area in particular, such that a proportion of coverage of the glass surface is considerably too large. Depending on color and application, this will generally require a coverage level of more than 15%. This is shown, for example, by a result that can be found in brochure https://vogelglas.vogelwarte.ch/downloads/files/broschueren/Glasbroschuere_2022_D.pdf on page 39 for versions No. 1, No. 2—coverage levels of printed solutions there are always 20-25% or 11%, associated with a corresponding distorting effect for the human eye.

What is called a laminate glass or laminate glass element is a composite composed of at least two flat glass panes joined by a tear-resistant and viscoelastic lamination film. Such glasses are used in particular in the construction sector, i.e. primarily as a facade element, but with appropriate safeguards also as a window element and/or facade element. If there is appropriate adhesion, laminate glasses are classified as laminated safety glass. For example, the prior art discloses laminate glasses in DE 23 13 278 A and DE 20 2008 008 318 U1.

A laminated safety glass (VSG) generally refers to a laminate glass of two glass panes and a film. The applicant's WO 2019/038288 A1 describes a laminate glass vision element that works with a laminate glass comprising a first and a second glass pane and a lamination film composite arranged between and bonded to the first and second glass pane, comprising a first and a second lamination film. The essence here of the special feature of visual functionality of the laminate glass vision element is that a multitude of sequins having a first light-absorbing surface is arranged between the first and second lamination film, where the sequins with the light-absorbing surface face the first lamination film and are in such a spaced-apart arrangement that the laminate glass has a transparent appearance on the side of the light-absorbing surface of the sequins.

Sequins are intrinsically known only in the field of clothing and, for example, are only described for this purpose in DE 230 759 and DD 295 720 A5 as reflective platelets in the field of clothing.

According to WO 2019/038288 A1, it is found that, surprisingly, sequins can be introduced particularly advantageously into the laminate glass vision element via the lamination film composite present therein, which brings particular advantages in several respects. One is that the laminate glass vision element according to WO 2019/038288 A1 as window element and/or facade element can also preferably be equipped with visual bird protection functionality, as described in US 2020/0262185 A1. The solution of sequins in a laminate glass vision element that are thus laminated between glass panes and additionally protected in a composite according to WO 2019/038288 A1 requires a surprisingly low and comparatively distinctly lower degree of coverage for effective bird protection; this is shown, for example, by a result that can be found in the brochure https://vogelglas.vogelwarte.ch/downloads/files/broschueren/Glasbroschuere_2022_D.pdf on page 39 for versions No. 3 or No. 6 to No. 8-a highly effective bird protection function can thus be achieved even with a coverage level of 0.8%.

The solution described in WO 2019/038288 A1, with a coverage of below 1%—and the fact that it is not positioned on the particular glass surface Pos1 labelled view (b) in FIG. 1A—thus sets new standards here.

However, the solution mentioned, which is extremely advantageous in itself, always requires the use of a laminate glass; this commonly incurs higher costs, namely at least because of the additional laminate glass pane and the additional composite film, and also costs for the lamination process, which can likewise be particularly energy-intensive.

However, the starting point for any type of glass facade is the individual glass, i.e. as single-pane glass; advantageously in the form of float glass. Single-pane glass may primarily take the form of unannealed or untempered single-pane glass; such general single-pane glass is referred to hereinafter for the sake of simplicity as “unannealed single-pane glass” or else as “float glass,” simple glass or simple flat glass or float glass or flat glass.

Single-pane tempered glass is referred to as single-pane safety glass (ESG) or semitempered glass (TVG). The latter is regularly used as laminate glass or laminated safety glass. If a single-pane safety glass breaks, it breaks down into small fragments of about 10 mm in size with blunt edges. If a semitempered glass (TVG) breaks, larger pieces form and the cracks extend as far as the glass edge. A residual load-bearing capacity is retained.

For example, a laminated safety glass has several safety features (puncture resistance, distinctly low risk of injury on splinters, residual load-bearing capacity after partial destruction) compared to a simple flat glass pane, by virtue of the lamination film used in the laminated safety glass, which is generally permanently bonded to the glass panes under the influence of heat and pressure and in some cases under vacuum. A crucial factor for classification of laminate glass as laminated safety glass is adhesion within the laminate.

Especially for facade designs, but also for indoor glass walls, there is an increasing demand for glass that is transparent or can be seen through only from the interior, which at the same time meets safety requirements. At the same time, particularly for architects and building owners, there is a need for maximum freedom of design in the configuration of the facade appearance.

Although the prior art, for example US 2009/0169795 A1, discloses use of known layer structures such as single-sidedly light-reflecting coated weaves or dot pattern films as insert in laminated safety glasses, these limit the adhesion of the composite and can only be produced consistently in limited widths, which greatly restricts use particularly in the case of large-area glass facade elements. Moreover, coated weaves are only producible over the entire area and with the same mesh sizes in each glass pane.

In contrast, fracture characteristics of unannealed single-pane glass (float glass) are not as controllable as those of a safety glass; however, it is nevertheless commonly found in a multitude of applications that annealed single-pane glass, and in particular single-pane safety glass, is not necessarily required—there is nevertheless found to be high interest in unannealed single-pane glass in particular (also sometimes referred to hereinafter as simple float glass).

It is additionally found that there is increased demand for a multiglazed glass vision element or insulation glass vision element, particularly one having broader functionality; in particular for a functional vision element of a double-glazed or triple-glazed visual glass or insulation glass element, preferably comprising or consisting of untempered or mainly untempered and/or unannealed single-pane glass, i.e. unannealed single-pane glass in the above general sense (sometimes also referred to hereinafter simply as float glass).

Thus, a notable portion or majority of the standard window elements and/or facade elements—even without safety features-is likely to be used as simple multiglazed glass elements or insulation glass elements; i.e. with unannealed single-pane glass in the above general sense (sometimes also referred to hereinafter simply as float glass). In the context of a simple double-glazed insulation glass element, reference is also made to simple double glazing or a simple double-glazed insulation glass. Accordingly, in the context of a triple-glazed glass element or insulation glass element, reference is also made to triple glazing or a triple-glazed insulation glass.

This is in particular a window element and/or facade element-one that is unprotected, i.e. has no safety feature—which has two glass panes, each as an unannealed single-pane glass, each separated by a pane interspace; it is often the case that these two glass panes and the pane interspace (SZR) are framed—for example, for presentation of a commercial standard window. It is customary to fill the pane interspace with an insulating gas such as argon or krypton. These are sealed airtight, but without vacuum.

There are also corresponding vacuum insulation glasses; if the pane interspace (SZR) is vacuumed, this is correspondingly referred to as a vacuum insulation glass. Accordingly, the abovementioned terms should be understood analogously for a triple-glazed glass element or insulation glass element when three glass panes are installed. This is analogously applicable to the multiglazed glass vision element or insulation glass vision element mentioned at the outset.

An up-to-date overview of the different products including what are called vacuum insulation glasses (VIGs) can be seen at https://www.tu-darmstadt.de/glass-cc/forschung/forschungsgebiete/produkte/produkte.de.jsp.

Of the known measures to counter bird strike, it is found that retrospective foiling over foils on the outside of existing window facades or the printing of glass panes, as elucidated above-whether as a retrofit or new-build element-virtually always takes place with partial or total foiling. Subsequent printing of glass panes is often not possible. Adhesive application of printed bird protection film is often difficult, since there is a high degree of coverage and high absorption, and hence the risk of thermal breakage of the glass pane.

Other glass processing operations also always require contact over part or all of the area, which is complex and usually cannot be implemented by the user themself. This, and the use of lifting platforms and weather dependency, incurs high costs. It is additionally found to be problematic that such solutions are usually also exposed to weathering and are therefore specifically not sustainable or impair the visual impression.

It is also desirable to provide an advantageous visual function for multiglazed glass or insulation glass elements, and hence an improved multiglazed glass vision element, in particular one that is also more broadly functionally configurable, in particular in the form of a window element and/or facade element for an installed state in a facade or in an interior configuration of a building space. This should be advantageously possible without increasing the number of processing steps of the glasses and hence the necessary energy requirement for the purpose. This should advantageously be possible, in particular, on the basis of unannealed single-pane glass in the general sense above (sometimes also referred to hereinafter simply as float glass).

### SUMMARY

In an embodiment, the present disclosure provides a multiglazed glass vision element including at least a first glass pane and a second glass pane, and at least one pane interspace between the first glass pane and the second glass pane that spaces them apart, where the glass panes with the at least one pane interspace are kept spaced apart by a spacer structure. A multitude of sequins are arranged in the multiglazed vision element to achieve a visual appearance. A sequin has a light-absorbing surface and a light-reflecting surface, and in an installed state of the multiglazed glass vision element, the light-absorbing surface faces a building interior and the light-reflecting surface faces a building exterior. The multitude of sequins are spaced apart from one another such that the multiglazed glass vision element appears transparent when viewed from a side of the light-absorbing surface and less transparent when viewed from a side of the light-reflecting surface. The multitude of sequins are applied on an inner face of one of the glass panes of the multiglazed glass vision element that faces the pane interspace.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A and 1B depict a schematic diagram of a comparative example of a construction of a multiglazed glass element or multiglazed insulation glass element with elucidation of the basic positions for the glass surfaces Pos1, Pos2, Pos3, Pos4 and terminology in a first variant (FIG. 1A) incorporating only one simple glass pane, and in a second variant (FIG. 1B) incorporating a laminate glass pane;

FIGS. 2A, 2B, 2C, and 2D depict variants of a sequence of coating and sequins on an inner face of a glass pane that faces the pane interspace, preferably as unannealed single-pane glass or nontempered float glass pane (but not excluding tempered single-pane safety glass (ESG)) of the multiglazed glass vision element-especially for a double-glazed glass vision element—with particular preference for the variants shown in FIGS. 2A and 2B;

FIGS. 2E, 2F, 2G, and 2H depict variants of a sequence of coating and sequins on an inner face of a glass pane that faces the pane interspace, as laminated safety glass VSG—preferably produced from nontempered float glass panes or semi-tempered glass panes—of the multiglazed glass vision element-especially for a double-glazed glass vision element—with particular preference for the variants shown in FIGS. 2E and 2F;

FIG. 3 depicts a schematic diagram of a construction of an exemplary embodiment of a functional multiglazed glass vision element or insulation glass vision element according to the first aspect of the present disclosure in a first and second variant, in view (a) with two glass panes and in view (b) with three glass panes, namely corresponding to the principle apparent from FIG. 2C;

FIG. 4 depicts a schematic diagram of a construction of an exemplary embodiment of a functional multiglazed glass vision element or insulation glass vision element according to the first aspect of the present disclosure in a first and second variant, in view (a) with two glass panes and in view (b) with three glass panes;

FIG. 5 depicts a schematic diagram of a particularly preferred construction of an exemplary embodiment of a functional multiglazed glass vision element or insulation glass vision element according to the first aspect of the present disclosure in a first variant in view (a) and second variant in view (b) for a triple-glazed glass vision element, namely corresponding to the principle apparent from two glass panes from FIG. 2B and FIG. 2A;

FIGS. 6A and 6B depict a schematic diagram of a construction of an exemplary embodiment of a functional multiglazed glass or insulation glass vision element according to the first aspect of the present disclosure, preferably with nontempered single-pane glass (FIG. 6A) and laminated safety glass VSG, preferably consisting of nonsemitempered glass panes (FIG. 6B);

FIG. 7 depicts an illustrative construction of a sequin for application directly on a glass pane;

FIGS. 7A and 7B depict the sequin of FIG. 7 set up by way of example with an adhesive in a first variant (FIG. 7A) for application on a glass surface Pos2 of a glass pane (e.g. according to the exemplary embodiment of FIG. 3 or FIG. 5 (view (b)), and in a second variant (FIG. 7B) for application on the glass surface Pos3 (for example according to the exemplary embodiment of FIG. 4 or FIG. 5 (view (a));

FIG. 8 depicts a flow diagram for elucidation of an exemplary embodiment of a sequence of a production process for a functional multiglazed glass vision element or insulation glass vision element; and

FIG. 9 depicts a flow diagram for elucidation of an exemplary embodiment of a sequence of a production process in which a multitude of sequins is arranged on the glass pane before cutting-to-size, in particular in strip measurement format, is still implemented within the float glass plant and energy-intensive operations are avoidable or optional.

### DETAILED DESCRIPTION

Embodiments of the present disclosure provide an improved multiglazed glass vision element, in particular for a window element and/or facade element for an installed state in a facade or in an interior configuration of a building space, in particular with a broader functional effect too, preferably with a visual bird protection functionality, in particular with a visual bird protection functionality that can be classified as highly effective. This improved multiglazed glass vision element is firstly sustainable and should not only offer an optimized visual impression but secondly also offers optimized freedom of configuration for facade or interior configuration in a sustainable manner. The multiglazed glass vision element is possible in particular on the basis of unannealed single-pane glass in the general sense above (sometimes also referred to hereinafter simply as float glass).

In embodiments of the present disclosure, the transparent multiglazed glass vision element, in particular one that is functional in a broader sense, is designed in particular for a window element and/or facade element. The transparent multiglazed glass vision element, in particular one that is functional in a broader sense, preferably has a visual bird protection functionality, in particular a visual bird protection functionality that can be classified as highly effective. Advantageously, the multiglazed glass vision element comprises single-pane glass based on unannealed single-pane glass in the above general sense (sometimes also referred to hereinafter as simple float glass).

Embodiments of the present disclosure include a window element and/or facade element for an installed state in a facade or in an interior configuration of a building space, including a multiglazed glass vision element.

Embodiments of the present disclosure include a use of the functional multiglazed glass vision element, in particular as a window element and/or facade element, preferably with a visual bird protection functionality.

A first aspect of the present disclosure includes the multiglazed glass vision element, in particular multiglazed insulation glass vision element, in particular for a window element and/or facade element for an installed state in a facade or in an interior configuration of a building space.

The multiglazed glass vision element has:
at least a first glass pane and a second glass pane and a pane interspace between the first glass pane and the second glass pane that spaces them apart, where the first glass pane and the second glass pane with the intervening pane interspace are kept spaced apart by a spacer structure.

According to embodiments of the present disclosure,
a multitude of sequins is arranged in the multiglazed glass vision element to achieve a visual appearance (E), where
a sequin has a light-absorbing surface and a light-reflecting surface, and in the installed state of the multiglazed glass vision element, the light-absorbing surface is intended to face a building interior and the light-reflecting surface is intended to face a building exterior, and
the sequins are spaced apart from one another in such a way that the multiglazed glass vision element appears transparent when viewed from the side of the light-absorbing surface of the sequins and appears less transparent when viewed from the side of the light-reflecting surface of the sequins, where
the multitude of sequins have been applied, in particular directly, on an inner face of one of the glass panes of the multiglazed glass vision element that faces the pane interspace.

In embodiments of the present disclosure, the sequins have particularly advantageously been applied on one of the first glass pane and second glass pane of the multiglazed glass vision element.

In an embodiment of the present disclosure, the multitude of sequins have advantageously been applied directly on an inner face of one of the glass panes of the multiglazed glass vision element that faces the pane interspace. This particularly advantageously includes application of the multitude of sequins directly on the inner face of one of the glass panes that faces the pane interspace. In an embodiment of the present disclosure, the multitude of sequins also have been applied directly on a coating of the inner face of one of the glass panes that faces the pane interspace.

Embodiments of the present disclosure have recognized, and made possible by the application of the multitude of sequins, in particular directly, on an inner face of the first and/or second glass pane that faces the pane interspace, that firstly sustainable visual functionality with an optimized visual impression is provided in the multiglazed vision element, and, secondly, optimized design freedom for facade or interior configuration is also offered. The sequins, and hence the entire multiglazed glass, in particular insulation glass, vision element, are protected from weathering and mechanical stress, for example children scraping off the dots.

In the case of the single-sidedly transparent multiglazed glass vision element or insulation glass vision element, in particular one that is functional in a broader sense, in particular a window element and/or facade element, preferably having visual bird protection functionality, the first and the second glass pane and a pane interspace disposed between the first and second glass pane are preferably essentially visually transparent or see-through. The distances between the multitude of spaced-apart sequins are thus preferably essentially visually transparent or see-through, such that the multiglazed glass vision element, in particular multiglazed insulation glass vision element, is largely visually transparent, or see-through in principle, only in the gaps.

However, light-absorbing structures, for example black or dark structures, are filtered out by the human eye, especially if they have high contrast from their surroundings; the structures appear to an observer to be neutral in color with respect to the surroundings, and they are not perceived.

The situation is different with reflective light-colored structures; these are apparent to a viewer. This means that, for example, the viewer can see through a window glass pane with a multitude of black stripes, i.e. they can clearly perceive the environment behind the glass pane; with a multitude of light-colored, i.e. reflective, stripes in the same arrangement, however, the viewer clearly perceives the stripes and the environment behind the glass is likely to be less perceptible or imperceptible to them. The light-colored structures create lower contrast from the surroundings than the black structures, meaning that the background behind the light-colored structures is perceived to a lesser degree and distorted with the light-colored structures.

Embodiments of the present disclosure find that the use of a multitude of sequins, by virtue of the lower coverage compared to dot pattern films, results in better achievability of the abovementioned improvements and in particular also the abovementioned further functional effects.

The use of a multitude of sequins, and also the use of individual sequins which, unlike the previously known dot pattern films or weaves, have no interconnected structure, result in distinctly greater degrees of freedom in arrangement and shapes, and hence freedom of design is restricted only to the extent that that only single-sided transparency is maintained.

Furthermore, the use of sequins also allows for simple production; this relates in particular to the creation of structures that change over the course of a glass pane, such as larger distances between sequins with increasing facade height. There is no need to use polymer films; the sequin dots are applied directly to the glass pane by machine.

This so-called “on glass” solution, elucidated here for the first time, sets new standards; as has been shown, a highly effective bird protection function is advantageously enabled even with a coverage of not more than 5%, in particular of not more than 3%. In particular, said coverage for a highly effective bird protection function may be less than 2%, preferably less than 1%, in particular less than 0.5%; the solution is additionally advantageous without full-area bonding of the window surfaces and it is not exposed to weathering and is protected from mechanical stress.

The application of the individual sequins directly on a glass pane, for example on an inner face of a first glass pane as outer pane, additionally obviates the need for the lamination foils required for lamination; there is no need for this and the associated energy-intensive lamination process with a second glass pane. Lamination foils for laminate glass are tear-resistant and viscoelastic; for example, polyvinylbutyral (PVB), ethylene-vinyl acetate (EVA), polyurethane (PU) or ionoplasts or ionomers, i.e. polymer materials with ionic bonds between the macromolecules in addition to the usual secondary valence bonds, are used here.

In the context of the present invention, sequins mean thin single-or multilayer platelets. “Light-absorbing” means an absorption of visible light of at least 60%. Structures or materials referred to as light-absorbing appear black or at least very dark to the human eye.

It is found that highly effective bird protection is already achieved even by a relatively open grid (for example a 9/70 mm grid, i.e. sequins with diameter 9 mm on a square dot pattern with edge length 70 mm) and correspondingly low coverage, at least of less than 3%. The given example of a 9/70 mm grid already enables highly effective bird protection with a coverage of only 1.25%. It is found that highly effective bird protection is also already achieved even with a very open grid-such as a 9/90 mm grid (i.e. sequins with diameter 9 mm on the vertices of a square dot pattern with edge length 90 mm) and correspondingly even lower coverage (of at least below 1%—the given example of a 9/90 mm grid enables effective bird protection with only a coverage of 0.8% or below).

As used herein “coverage” refers to the area coverage of the sequins on glass in relation to a standard glass surface.

The additional features of the exemplary embodiments described herein can be combined with one another to form further aspects, unless they are expressly described in the description as alternatives to one another.

It is advantageous that the glass panes of the multiglazed glass vision element consist of unannealed single-pane glass, in particular simple float glass.

In an advantageous first aspect for an embodiment of the present disclosure, at least the first glass pane and the second glass pane, in particular optionally a third glass pane, takes the form of an unannealed single-pane glass, in particular simple float glass.

In an advantageous second aspect for an embodiment of the present disclosure, at least the first glass pane takes the form of a laminate glass with unannealed single-pane glass, in particular simple float glass, or laminated safety glass, and the second glass pane, and in particular optionally a third glass pane, takes the form of an unannealed single-pane glass, in particular simple float glass.

The application of the sequins makes it possible to use nontempered glass panes—i.e. unannealed single-pane glass as mentioned above, in particular simple float glass. This eliminates the energy-intensive tempering process. The sequins can be applied in the float glass plant in particular, especially before cutting to strip measurement format. The application of the sequins thus makes it possible to use nontempered glass panes in strip measurement format, in particular before cutting to size; as explained, this relates in particular to simple float glass.

The aforementioned aspects of embodiments of the present disclosure also has the advantage that an additional glass pane—required for a laminate glass-can be largely dispensed with. In addition, a lamination process becomes superfluous if the sequins are applied directly on an unannealed single-pane glass. The resulting additional energy expenditure and CO2 in the course of production can advantageously be avoided. Since a single-pane glass is additionally thinner than a laminate glass pane, the resultant weight in a facade is avoided.

It is advantageous that—as already explained above—the multitude of sequins are applied, in particular directly, on the inner face of one of the glass panes, in particular the first and/or second glass pane, that faces the pane interspace. In an embodiment of the present disclosure, the multitude of sequins can be applied directly to a coating of the inner face of one of the glass panes, in particular the first and/or second glass pane, that faces the pane interspace. Examples of both variants are elucidated in the exemplary embodiments with reference to the figures.

Advantageously, the multitude of sequins may be applied exclusively on the inner face of the first and/or second glass pane that faces the pane interspace, especially exclusively on the inner face of the first and/or second glass pane of a double-glazed glass vision element or of a triple-glazed glass vision element that faces the pane interspace. This has the advantage that the sequins are outwardly effective as close as possible to the exterior—largely unhindered by any glass coating in front.

It is advantageous that
in the installed state of the multiglazed glass vision element, the first glass pane is intended to face a building exterior as outer pane and the second glass pane is intended to face a building interior as inner pane.

It is advantageous that, for formation of the multiglazed glass vision element as a double-glazed glass vision element, the first glass pane and the second glass pane are the only glass panes of the multiglazed glass vision element.

It is advantageous that, for formation of the multiglazed glass vision element as a triple-glazed glass vision element, the multiglazed glass vision element, in addition to the first glass pane and second glass pane, has a third glass pane, and a pane interspace between the second glass pane and the third glass pane that spaces them apart, where the second glass pane and the third glass pane with the intervening further pane interspace are kept spaced apart by a spacer structure, where the third glass pane is intended to face a building interior as inner pane.

In other words, it is advantageous that, after the second glass pane, a further pane interspace with a third glass pane is kept spaced apart by the spacer structure for formation of the multiglazed glass vision element as a triple-glazed glass vision element.

It is advantageous that the spacer structure is formed as a peripheral frame for the first and second glass panes, and optionally also the third glass pane, by means of which the first and second glass panes, and optionally also the third glass pane, are framed in a spaced-apart manner.

It is advantageous that the pane interspace that spaces apart the first and second glass panes, and optionally also the further pane interspace that spaces apart the second glass pane and third glass pane, is air-free, for formation of the multiglazed glass vision element as a multiglazed insulation glass vision element.

It is advantageous that, for an insulation glass vision element, the entire pane interspace or the number of pane interspaces—in the present case the pane interspace and/or the further pane interspace—is filled with insulating gas, in particular argon or krypton, or is air-free, in particular vacuumed, preferably for isolation of the multiglazed glass vision element and formation as a multiglazed insulation glass vision element.

It is advantageous that the first and the second glass panes, and optionally also the third glass pane, are kept spaced apart by the spacer structure comprising one or more spacer elements in the intervening pane interspace in the viewing region of the pane.

It is advantageous that the spacer element is formed by means of one or more, in particular all, of the multitude of sequins on the first and/or second glass pane; in particular, a sequin forms a spacer element.

It is advantageous that a sequin for formation of a spacer element is flat and the sequin has a height that extends across the pane interspace.

It is advantageous that, for a vacuum insulation glass vision element, the pane interspace is vacuumed wholly or partly to form the multiglazed glass vision element as a multiglazed vacuum insulation glass vision element.

It is advantageous that a sequin has been applied, in particular directly, on an inner face of the first and/or second glass pane that faces the pane interspace by means of an adhesive or similar bonding agent. In an embodiment of the present disclosure, a sequin has been applied on a, in particular directly, on an inner face of the second and/or third glass pane that faces the further pane interspace by means of an adhesive, bonding agent or similar application means.

It is advantageous that, in the multiglazed glass vision element, the light-reflecting surface of a sequin has metallic or metal oxide reflectivity, and/or in which the light-absorbing surface of a sequin is black.

It is advantageous that, in the multiglazed glass vision element, a sequin has a layer structure comprising a decorative film and a light-absorbing layer.

It is advantageous that, in the multiglazed glass vision element, the decorative film comprises a polymer film having metallic or metal oxide reflectivity and/or in which the light-absorbing layer is a light-absorbing polymer film or a light-absorbing coating of the decorative film.

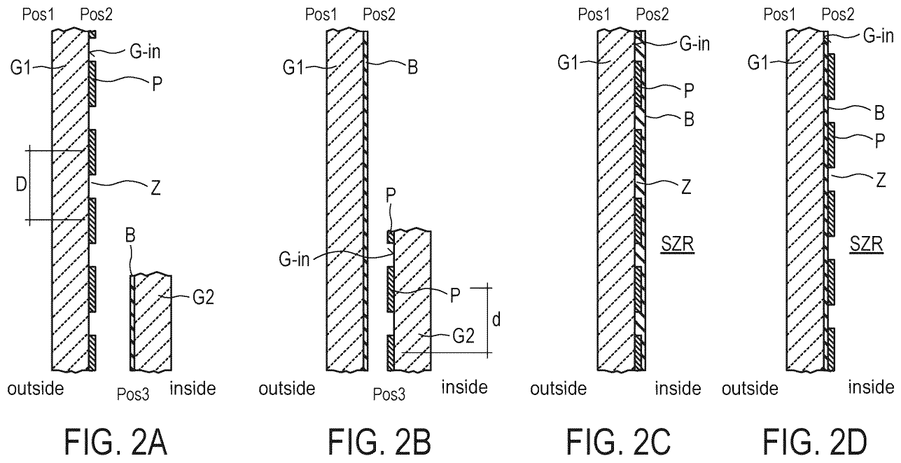

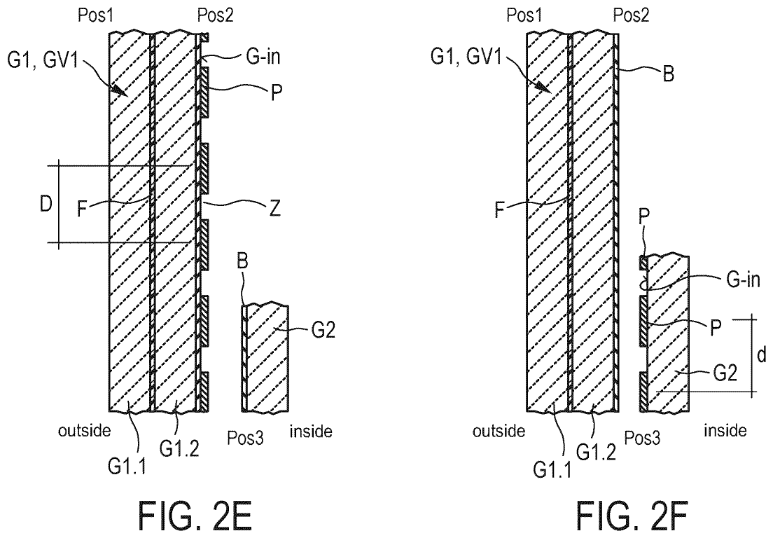

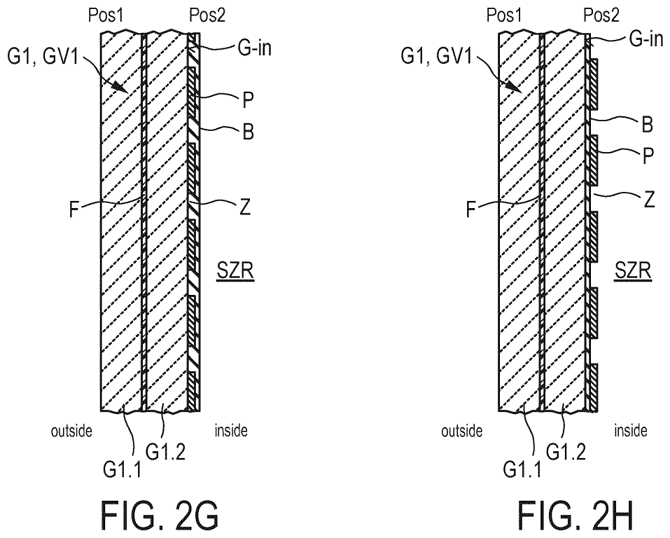

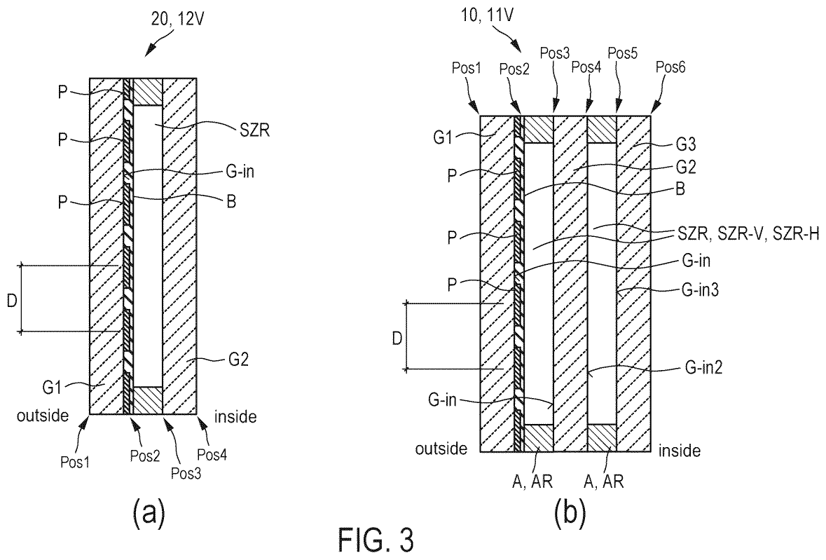

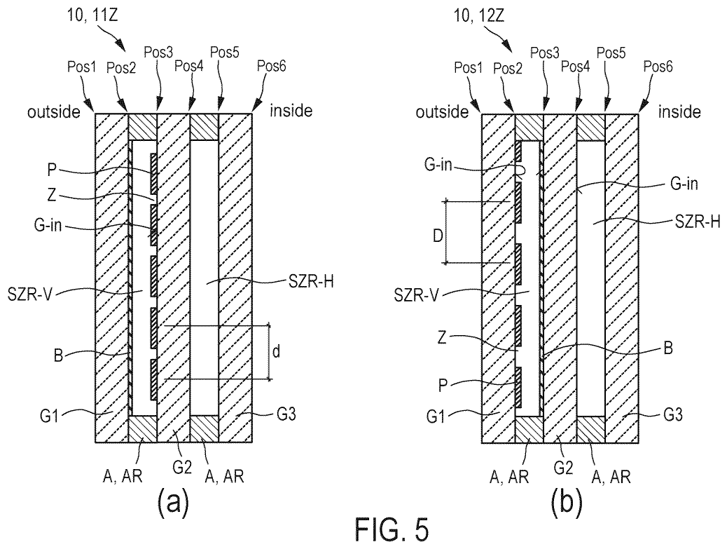

It is advantageous that a sequin has been applied, in particular directly, on an inner face of the first glass pane that faces the pane interspace, said first glass pane being intended to face a building exterior as outer pane, wherein
the second light-reflective surface of the sequin has been applied, in particular directly, on the inner face of the first glass pane that faces the pane interspace, in particular on the basis that the light-reflective surface of the sequin bears an adhesive. The first glass pane may more preferably take the form of a glass pane of unannealed single-pane glass, in particular simple float glass, as for instance in FIG. 2A, FIG. 2C, FIG. 2D, or of a laminate glass pane with unannealed single-pane glass, in particular simple float glass, as in FIG. 2E, FIG. 2G, FIG. 2H. Further, exemplary embodiments for this aspect are shown and elucidated with their advantages particularly in FIG. 3 in view (a) and (b) and FIG. 5 in view (b).

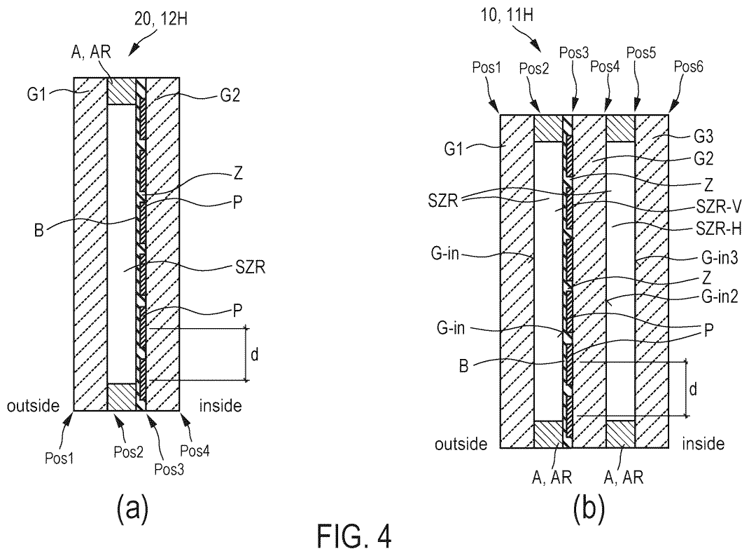

It is advantageous that, in one variant, a sequin has been applied, in particular directly, on an inner face of the second glass pane that faces the pane interspace, said second glass pane being intended to face a building interior as inner pane, wherein -the first light-absorbing surface of the sequin has been applied, in particular directly, on the inner face of the second glass pane that faces the pane interspace, in particular on the basis that the light-absorbing surface of the sequin bears an adhesive. The first glass pane may more preferably take the form of a glass pane of unannealed single-pane glass, in particular simple float glass, as for instance in FIG. 2B, or of a laminate glass pane with unannealed single-pane glass, in particular simple float glass, as in FIG. 2F. Further, exemplary embodiments for this aspect are shown and elucidated with their advantages in FIG. 4 and FIG. 5 in view (a).

It is preferable that the inner face facing the pane interspace in that glass pane which is opposite the glass pane populated with sequins has a glass coating. In other words, in particular, the inner faces adjoining the “front” glass interspace bordering the first glass pane as outer pane—i.e. the glass interspace closest to the exterior—should preferably be utilized first, either for application with sequins or a coating. This has the advantage that the sequins can thus display a particularly readily apparent functional effect to the outside, since they are disposed “closest to the exterior.”

The sequins are additionally advantageously applied to the glass pane opposite the coated glass pane; this prevents the effect of the coating from being reduced otherwise. If sequins have preferentially been applied to the inner face of the first glass pane, the inner face of the second glass pane will bear a coating. If the inner face of the first glass pane likewise preferentially bears a coating, the inner face of the second glass pane will have been populated with sequins. In the latter case, a lateral spacing of the sequins should be smaller than a lateral spacing of the sequins in the former case.

In particular, in the context of a combination with one of the aforementioned aspects, and also in general and independently thereof, it has been found to be advantageous that, in a group of aspects mentioned here as the first version—elucidated, for example, in relation to the exemplary embodiments in FIG. 2A, FIG. 2B and FIG. 2E, FIG. 2F and FIG. 5—a sequin is applied directly on an inner face of the first or second glass pane that faces the pane interspace, i.e. in the present case without a coating between the glass pane and the sequin.

In particular, in one aspect, it is optional for this purpose for a coating to be disposed on the sequin, as is the case in relation to the exemplary embodiments in FIG. 2C, FIG. 2G and FIG. 3 and FIG. 4.

In particular, in the context of a combination with one of the aforementioned aspects, and also in general and independently thereof, it has been found to be advantageous that, in a group of aspects mentioned here as the second version—elucidated, for example, in relation to the exemplary embodiments in FIG. 2D and FIG. 2H—a sequin is applied on an inner face of the first or second glass pane that faces the pane interspace, and is applied here to a coating between the glass pane and the sequin.

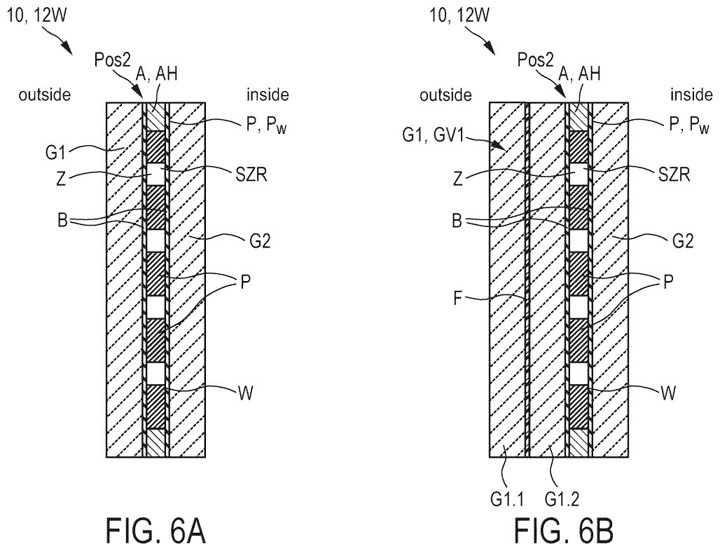

In particular, in the context of a combination with one of the aforementioned aspects, and also in general and independently thereof, it has been found to be advantageous that, in a group of aspects mentioned here as the second version—elucidated, for example, in relation to the exemplary embodiments in FIG. 6A and FIG. 6B—a sequin is in contact with the first glass pane and the second glass pane, where the sequin has been applied to an inner face, of one of the first glass pane and of the second glass pane, that faces the pane interspace. This can advantageously be effected without a coating on one of the glass panes, in particular without a coating on that glass pane that has been populated with sequins. However, it is also possible for neither of the two glass panes to have a coating. For the sake of better comprehensibility, in the exemplary embodiment of FIG. 6A and FIG. 6B, each of the glass panes may have been provided with a coating; both or at least one of the coatings may be omitted. For this purpose, a sequin may have been applied by means of an adhesive, bonding agent or similar application means on one of the glass panes and may lie against the other of the two glass panes.

It is advantageous that a multitude of sequins is disposed on the first and/or second glass pane to achieve a visual appearance, while the sequins on the first glass pane as outer pane have a first lateral spacing from one another, and the sequins on the second glass pane as inner pane have a second lateral spacing from one another, where the second lateral spacing is less than the first lateral spacing.

It is advantageous that the sequins are formed and/or spaced apart from one another so as to form a functional grid for configuration of a functional visual function and/or protective function of the multiglazed glass vision element against an external action, wherein the external action is selected from the group consisting of: bird protection, sun protection, heat protection.

It is advantageous that a bird protection grid is formed in that an area coverage as a ratio of the total area of the multitude of sequins per unit area of the multiglazed glass vision element is less than 5%, in particular less than 3%, in particular less than 2%, in particular less than 1%, in particular less than 0.5%. A 3/50 mm grid as the preferred solution for the vacuum insulation glass results in a coverage of 0.28%.

A 3/50 mm grid (i.e. sequins of diameter 3 mm in a square dot pattern with edge length 50 mm) or a grid in that order of magnitude is a preferred solution for vacuum insulation glass (VIG). Preferably, such a 3/50 mm grid leads to a coverage of only 0.28% with nevertheless effective visual function, in particular for effective bird protection. This is especially the case with bird protection grids—in other applications, the coverage could be distinctly higher.

It is advantageous that the light-reflecting surface, in particular having metallic or metal oxide reflectivity, of a sequin has a semitransparent layer having
significantly elevated reflectance in the nonvisible spectral region (non-VIS) compared to a reflectance in the visible spectral region (VIS) and/or
significantly lowered transmittance in the nonvisible spectral region (non-VIS) compared to a transmittance in the visible spectral region (VIS). This has the advantage that a reflection of a sequin which is particularly readily perceptible to birds outside the visible spectral region (non-VIS) is amplified with particularly high efficiency.

Embodiments of the present disclosure include a production method for the functional multiglazed insulation glass vision element, in particular one or more of the aspects of the type elucidated above.

The production process for the multiglazed glass vision element is characterized by the steps:
providing a first and a second glass pane,
arranging a multitude of sequins on the first glass pane and/or second glass pane to achieve a visual appearance, wherein
a sequin has a light-absorbing surface and a light-reflecting surface, and in the installed state of the multiglazed glass vision element, the light-absorbing surface is intended to face a building interior and the light-reflecting surface is intended to face a building exterior, and
the sequins are spaced apart from one another in such a way that the multiglazed glass vision element appears transparent when viewed from the side of the light-absorbing surface of the sequins and appears less transparent when viewed from the side of the light-reflecting surface of the sequins, where
the multitude of sequins are applied on an inner face of one of the glass panes of the multiglazed glass vision element that faces the pane interspace, in particular directly on the inner face of one of the glass panes that faces the pane interspace or directly on a coating of the inner face of one of the glass panes that faces the pane interspace,
using the first and/or second glass pane to form a multiglazed glass vision element.

It is preferable that the arranging of the multitude of sequins on the first glass pane and/or second glass pane to achieve a visual appearance precedes cutting-to-size and/or to a strip measurement format, in particular in the float glass plant.

Embodiments of the present disclosure are described hereinafter with reference to the drawing by comparison with the prior art, which is likewise illustrated to some degree. The drawing is not necessarily intended to represent the embodiments to scale; instead, where useful for elucidation, it is done in schematic and/or slightly distorted form. With regard to supplementations of the teachings that are apparent from the drawing, in particular directly, reference is made to the relevant prior art. It should be noted here that various modifications and alterations relating to the form and detail of an embodiment can be made without departing from the general concept of the present disclosure. The features of the present disclosure that are disclosed in the description, in the drawing, and in the claims may be essential to the development of the present disclosure, either individually or in any combination. In addition, all combinations of at least two of the features disclosed in the description, drawing, and/or claims are covered by the scope of the present disclosure.

Embodiments of the present disclosure are not limited to the exact form or detail of those shown and described below, or limited to subject matter that would be restricted by comparison with the subject matter claimed in the claims. In the case of specified design ranges, values that are within the specified limits shall also be disclosed as limit values and are usable and claimable as desired.

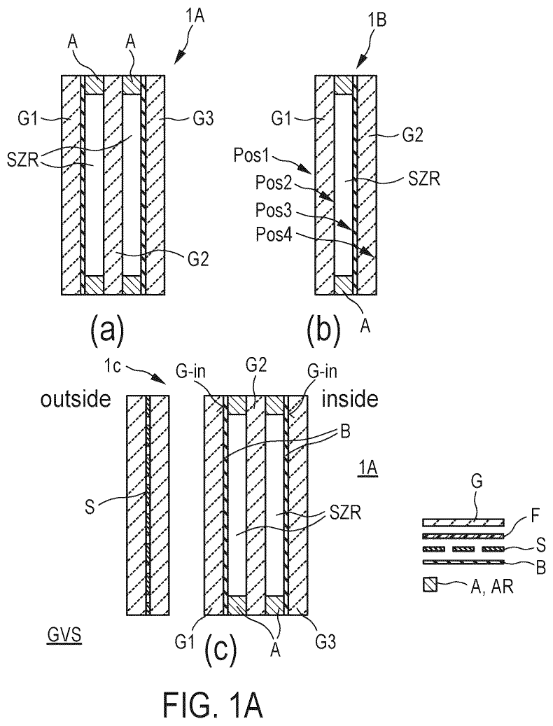

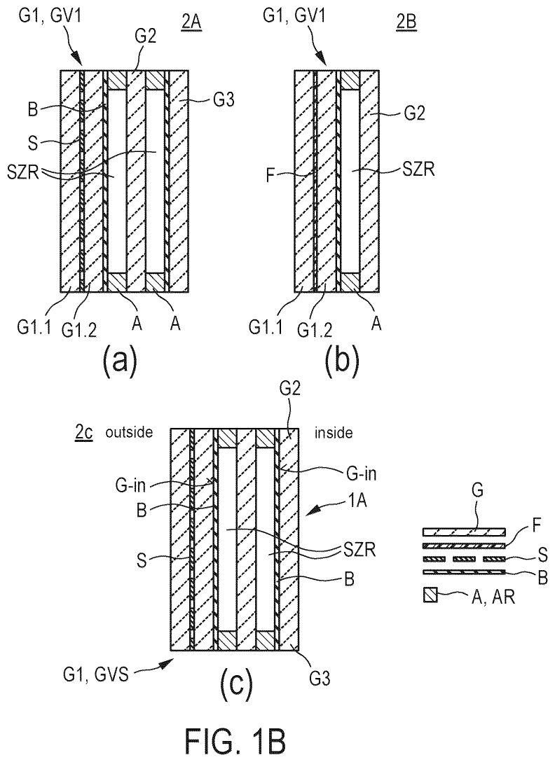

FIG. 1A and FIG. 1B show-in diagrams (a) and (b) in the respective upper rows of FIG. 1A and FIG. 1B—a multiglazed glass element 1A, 1B and, in FIG. 1B, a multiglazed glass element 2A, 2B in the form of a window and/or facade element for an installed state in a facade or in an interior configuration of a building space. The multiglazed glass element 1B and 2B shown in the upper diagrams (a) and (b) of FIG. 1A, FIG. 1B has a first glass pane G1 and a second glass pane G2, and a pane interspace SZR between the first and second glass pane G1, G2 that spaces them apart.

The multiglazed glass element 1 may be designed as a double-glazed glass element 1B, 2B, as shown in views (b) of FIG. 1A and FIG. 1B. The labels are chosen in a correspondingly analogous manner. The views (b) show double-glazed glass elements with naturally a single pane interspace SZR.

The pane interspace SZR in the case of the triple-glazed glass elements-even though the views (a) are actually a front pane interspace SZR-V closest to the exterior “on the outside” and a rear pane interspace SZR-H closest to the interior “on the inside”—which will at first be referred to as SZR as a whole.

For instance, the multiglazed glass element 1A, 2A in the exemplary embodiment shown in FIG. 1A or FIG. 1B does not take the form of a double-glazed glass element in the present context, but rather of a triple-glazed glass element 1A, 2A with a third glass pane G3 as well, which is effectively disposed-following the sequence from the exterior “on the outside” to the interior “on the inside”—behind the second glass pane G2 as a third glass pane G3, leaving a rear pane interspace SZR-H. In this respect, the pane interspace SZR in the triple-glazed glass element consists in the present case of a first and second pane interspace; which is apparent here as the front pane interspace SZR-V (from the second glass pane G2 to the first glass pane G1 as the outer pane) and rear pane interspace SZR-H V (from the second glass pane G2 to the third glass pane G3 as the inner pane).

It is also possible—as apparent in FIG. 1B in the upper diagrams (a) and (b)—for the first glass pane G1 (and optionally also additionally or alternatively the middle and inner glass pane, i.e. the second glass pane G2) to be executed as laminate glass pane GV1.

This type of laminate glass pane GV1 on its own (i.e. G1.1, G1.2 with film F or film composite F)—effectively as a laminated safety glass VSG composed of float glass panes already constitutes an advantageous solution compared to a printed solution.

It has been found that a printed glass can only be equipped with a heat or sun protection coating needed for an insulation glass with additional high energy expenditure. An internal solution for a highly effective bird protection visual function is barely achievable by a printing process, if at all; at least not on the glass surface Pos2 visible in FIG. 1A in the upper diagrams (b).

Otherwise, the solution of a laminated safety glass pane (VSG) requires at least one further, likewise annealed glass pane, which additionally has to be laminated to a laminated safety glass in a likewise energy-intensive process. In this case, the heat or sun protection layer is on the unprinted glass pane.

The laminate glass pane GV1 has—as shown in FIG. 1B—at least one laminate glass layer G1.1 intimately bonded to a film F; the film F may—as shown in FIG. 1B in all views—also be between a first and second laminate glass layer G1.1, G1.2. In this context, the reference symbol F denotes a single film in this respect. A simple laminate glass may also be bonded solely to a single film F.

It may be a laminate glass but also—as shown in FIG. 1B, diagram (a) and (c)—be formed with a film composite S. If, for example, sequins, as elucidated in WO 2019/038288 A1, are to lie between the two films, two films, i.e. a film composite, such as the composite structure film S described here, are used.

Again, as elucidated above, the multiglazed glass element 2A with the laminate glass pane GV1 can also be designed as a double-glazed glass element 2B, which is shown on the right in view (b), with corresponding designation and corresponding analogous description.

The elements of the common listing in FIG. 1A and FIG. 1B (bottom right on the page) may in principle be features of the multiglazed glass element 1A, 1B, 2A, 2B, namely a glass pane G, a composite structure film S, a coating B, a simple film F and/or a spacer structure A, in particular frame AR.

The spacer structures A may be supplemented by a frame AR or the like or form such a frame in order to keep the glass panes G1, G2, G3 spaced apart and to tightly seal the pane interspace SZR.

The multiglazed glass element 1A, 1B or 2A, 2B may thus be formed as an insulation glass element, where the pane interspace SZR is wholly or partly vacuumed, in particular for insulation. In an embodiment of the present disclosure, the multiglazed glass element 1A, 1B or 2A, 2B may be formed as a glass element, where the pane interspace is provided with insulating gas, in particular argon or krypton, for insulation; in particular, it is additionally possible to use butyl for airtight sealing of the frame of the insulation glass.

The glass surfaces Pos1, Pos2, Pos3, Pos4 labelled in view (b) of FIG. 1A are shown here in simplified form and are likewise used hereinafter to describe the positions in the multiglazed glass elements 1A, 1B or 2A, 2B where there are further features that will become relevant. The reference symbols Pos1, Pos2, Pos3, Pos4, Pos5, Pos6 are suitable in the present context for defining the relevant glass surfaces on the first, second and third glass pane G1, G2, G3—however, they only partly reflect the ways of counting an indication of position that are customary in the field, which sequentially take account of all surfaces of the multiglazed glass element, counted from the outside inward; if necessary, especially in the case of composite glass panes, these are listed separately in the description as “positions.”

For instance, in views (a) in FIG. 1A, it is apparent that, on the glass surface Pos2 of the first glass pane G1 as outer pane, i.e. directly on an inner face facing the pane interspace SZR (the front pane interspace, also referred to hereinafter as SZR-V), the first glass pane G1 has been provided with a coating B; a coating B may-as shown in view (b) of FIG. 1A—also be present as inner pane on a glass surface Pos3 of the second glass pane G2. In view (a) of FIG. 1B, the coating B is also disposed directly on an inner face of the first glass pane G1 that faces the pane interspace SZR (the front pane interspace, also referred to hereinafter as SZR-V); the first glass pane G1 here is formed from laminate glass, i.e. as a laminate glass pane GV1.

The respective lower diagram (c) in FIG. 1A and FIG. 1B then shows how such a type of multiglazed glass elements 1A, 1B or 2A, 2B can be supplemented in order to be provided with a visual function; i.e. by an additional installation or special design of the laminate glass pane GV1 in the manner of a laminate glass vision element GVS that can be provided with a functional composite structure film S.

A particularly preferred type of laminate glass vision element GVS is described in the applicant's WO 2019/038288 A1, the contents of which are hereby incorporated into the disclosure content of this application by reference.

FIG. 1A at the bottom—in diagram (c)—shows that a laminated safety glass VSG is separately disposed in front of the triple-glazed glass element 1A-FIG. 1A at the top in view (a)—in order to establish an arrangement 1C of the multiglazed glass element 1A with the laminate glass vision element GVS. This can be done, for example, in the case of a facade.

FIG. 1B at the bottom—in diagram (c)—shows that a laminated safety glass VSG can be utilized to form a triple-glazed glass element like view (a) of FIG. 1B at the top, in order to establish an arrangement 2C of the multiglazed glass element 1A with the laminate glass vision element GVS. This can be done, for example, in the case of a facade.

However, this has to be produced in full, namely including the laminate glass pane GVS, which is provided with an additional visual functionality. Moreover, it has to be taken into account that an additional laminate glass pane GVS, as required in the example of arrangement 1C in FIG. 1A or arrangement 2C in FIG. 1B, requires at least two glass panes. The resulting additional energy expenditure and CO₂ in the course of production and the resultant weight in a facade can advantageously be avoided. Using an example of a typical facade with an area of 10 000 m2 , it can be estimated that a glass thickness saving of as little as 2 mm can lead to a weight saving of 50 t or more.

Proceeding from these options, it is desirable to provide a multiglazed glass vision element in which the visual functionality is already integrated into a multiglazed glass element; i.e. preferably without having to aim for a laminate glass solution and hence also to avoid corresponding energy expenditure and CO2 in production and weight in use.

Advantageously, the multiglazed glass vision element additionally offers a reduced energy requirement in the course of production; it is found that even the saving of one laminate glass vision element GVS—separately as in FIG. 1A, view (c) or as part of the whole as in FIG. 1B, view (c)—will bring considerable energy savings.

It is possible to supplement the design of the multiglazed glass vision element of a broader function, preferably to provide it with a visual bird protection functionality. The multiglazed glass vision element according to embodiments of the present disclosure are firstly not only be sustainable, but additionally offer an optimized visual impression that offers optimized design freedom for facades or interior configuration and is still sustainable.

Glass visible to birds is becoming increasingly important, especially with solutions classified as highly effective. However, printed glass with a visual function or with a broader functional effect, in particular as a bird protection solution, always requires printing on an external position (identified by glass surface Pos1 in FIG. 1A), i.e. on the outside of a glass pane G1 as outer pane. This means that this solution is subject to higher soiling; for example, the question of warranty obligations arises.

Printing also requires quite a complex production process including annealing of the glass pane—which is energy-intensive and is potentially associated with a deterioration of the glass quality caused by “roller waves.”

The solution in this respect of sequins in the laminate glass vision element that have been laminated between glass and additionally protected in the composite, according to WO 2019/038288 A1, sets new standards here with a coverage of less than 1% and the fact that it is not on the glass surface Pos1 more specifically identified in FIG. 1A, view (b), and does not require annealed glass. However, it still requires the use of a laminate glass; this will regularly incur higher costs, namely because of the additional laminate glass pane and the additional composite film, and also costs for the lamination process, which can likewise be particularly energy-intensive.

The embodiments of what is called an “on glass” solution with a functional effect that are elucidated here for the first time according to the present disclosure that are presented in embodiments of FIG. 2 to FIG. 8 set new standards; a coverage of probably not more than 3% will be required to enable a functional effect. The solution does not need full-area bonding of window surfaces and is not subject to weathering; the embodiments of FIG. 2 to FIG. 8 that are presented according to the present disclosure provide for an application for achievement of a functional effect only for a preferred glass surface Pos2, Pos3 and possibly higher (i.e. glass surface Pos4, Pos5); i.e. solutions of the invention are protected from mechanical stress on the glass surface; this is not the case with a glass surface Pos1.

The novel solution according to the present disclosure therefore fundamentally does not require either an additional glass pane or a lamination film or a laminating process between glass; there is also no need for complex large-area films for applying to glass (and they accordingly do not need to be disposed of either). There is also no need for energy-intensive annealing of glasses of the present disclosure, which, by comparison, is necessary in the case of a glass printed on glass surface Pos1.

The novel solution based on the present disclosure is also less costly. It will also be more sustainable. Illustrative embodiments of FIG. 2 to FIG. 8 are now described, and these offer versatile applications with a correspondingly high demand and market share.

This type of multiglazed glass vision elements according to the concept of the invention is used in two exemplary embodiments of FIG. 2 to FIG. 6 with four exemplary variants of FIG. 3, FIG. 4 and FIG. 5 and FIG. 6, and in particular the modifications of FIG. 3 and FIG. 5 have been found to be useful.

Reference is made first of all to the exemplary variants of FIG. 2A, FIG. 2B and FIG. 2C and FIG. 2D: these show variants of a sequence of a coating and a sequin arrangement on an inner face of one of the glass panes G1, G2 that faces the pane interspace SZR—preferably as an unannealed single-pane glass, in particular simple float glass—of the multiglazed glass vision element; in other words, with regard to glass surface Pos2 on the first glass pane G1 and glass surface Pos3 on the second glass pane G2. The exemplary variants show a sequence of a coating B and an arrangement of sequins P on an inner face of one of the glass panes of the multiglazed glass vision element that faces the pane interspace.

In the embodiments shown in FIG. 2A, FIG. 2C, FIG. 2D, a multitude of sequins P are arranged on the first glass pane G1 to achieve a visual appearance; the sequins are arranged in a first exemplary variant directly on an inner face G-in of the first glass pane G1 that faces the pane interspace SZR (the front pane interspace SZR-V) to achieve a visual appearance.

According to the exemplary variant of FIG. 2C, the sequins P and the inner face G-in of the first glass pane G1 may have been coated with a coating B. According to the exemplary variant of FIG. 2D, it is also possible for the whole inner face G-in of the first glass pane G1 first to be coated with a coating B, and the sequins P can be applied to the coating B.

According to the exemplary variant of FIG. 2B, it is possible that the multitude of sequins P are applied, in particular directly, on an inner face G-in of the second glass pane G2 that faces the pane interspace SZR.

In other words, the sequins P are applied on the first glass pane G1 on the glass surface Pos2 according to the embodiment of FIG. 2A. In other words, the sequins P are applied on the second glass pane G2 on the glass surface Pos3 according to the embodiment of FIG. 2B. The embodiment of FIG. 2B may also be provided, in a variation, with an arrangement of sequins P and a coating B on the inner face G-in of the second glass pane G2, as shown in FIG. 2C and FIG. 2D using the example of the first glass pane G1.

It is likewise possible in principle to apply the sequins P to both glass surfaces Pos2 and Pos3.

Overall, it has been found to be superior and advantageous that the first and/or second glass pane G1, G2 has sequins P applied directly on its inner face G-in.

It is particularly advantageous when-as is the case in the embodiments of FIG. 2A and FIG. 2B—only the first or second glass pane G1, G2 has sequins P applied directly on its inner face G-in. In any case, in these two latter cases that have been mentioned and detailed, the coating B thus lies on the glass pane opposite the glass pane populated with sequins P. Thus, if the sequins are positioned-as in FIG. 2A—on the inner face G-in of the outer glass pane G1 (on glass surface Pos2), the coating B on the outer face G-in of the inner glass pane G2 (on glass surface Pos3) is in the pane interspace SZR. The sequins P are thus positioned in front of the glass coating B in a viewing direction oriented from the outside inward; this has the advantage that they are perceptible from the outside unaffected by the coating B-the effect of the sequins is thus optimized and a lateral spacing of the sequins can be wider compared to the situation of FIG. 2B.

In the variant shown in FIG. 2B, the “reverse” version is apparent, in which the coating B is on the inner face of the outer glass pane G1, but the sequins P are on the outer face of the inner glass pane G2. The sequins P are thus positioned behind the glass coating B in a viewing direction oriented from the outside inward. The sequins P are thus perceptible from the outside in a manner influenced by the coating B.

If the sequins—viewed from “the outside”—are thus in front of the glass coating B (FIG. 2A), the spacing D between the sequins-in particular with the functional effect of a bird protection solution—is advantageously greater than the spacing d when the sequins P—viewed from the “outside”—are behind the coating B (FIG. 2B).

If the sequins—viewed from the “outside”—are in front of the glass coating B (FIG. 2A and also see below, FIG. 2E), the spacing D between the sequins P—in particular with the functional effect of a bird protection solution—is advantageously greater; this can preferably already be achieved with a very open grid—for example a 9/90 mm grid; in other words, sequins with diameter 9 mm on the vertices of a square dot pattern with edge length 90 mm. This comparatively very open grid has a correspondingly very low coverage of in any case less than 1%. The given example of a 9/90 mm grid enables highly effective bird protection even with only a coverage of 0.8% or lower.

If the sequins—viewed from the “outside”—are behind the coating B (FIG. 2B and also see below, FIG. 2F), the spacing d between the sequins P—in particular with the functional effect of a bird protection solution-is lower since the attenuating effect of the coating B should be compensated for via the shorter spacing d when the sequins P—viewed from the “outside”—are behind the coating B. It is nevertheless found that highly effective bird protection is already achieved even with a relatively open grid—such as a 9/70 mm grid (i.e. sequins with diameter 9 mm on the vertices of a square dot pattern with edge length 70 mm) and correspondingly lower coverage (of at least below 2%—the given example of a 9/70 mm grid enables effective bird protection with only a coverage of 1.25%).

FIG. 2A and FIG. 2B each show the embodiment of a multiglazed glass vision element, preferably namely in a double-glazed glass vision element; FIG. 5, view (b), and FIG. 5, view (a), show corresponding analogous embodiments 20, 12Z and 10, 11Z of a triple-glazed glass vision element.

FIG. 2C shows the embodiment of a multiglazed glass vision element, preferably namely in a double-glazed glass vision element; FIG. 3, view (a), shows a corresponding complete double-glazed glass vision element 20, 12V, and FIG. 3, view (b), shows a corresponding analogous embodiment of a triple-glazed glass vision element 10, 11V; each of these with the sequins on the first glass pane G1. The variants of this with the sequins on the second glass pane G2 are shown analogously in FIG. 4, view (a), and FIG. 4, view (b).

Reference is additionally made to the variants of FIG. 2E, FIG. 2G and FIG. 2H: these show variants of a sequence of coating and a sequin arrangement on an inner face G-in of the first glass pane G1 that faces the pane interspace SZR in the form of the single laminate glass pane GV1; in other words, here specifically the inner face G-in of the glass pane of the laminate glass plane GV1 labelled G1.2 in the multiglazed glass vision element; in other words, with regard to glass surface Pos2, on the first glass pane G1, namely the glass pane G1.2 of the laminate glass pane GV1 and glass surface Pos3 on the second glass pane G2 thereof. FIG. 2F shows a variant with the arrangement of the sequins P on an inner face G-in of the second glass pane G2 that faces the pane interspace SZR. A method of counting position which is customary in the field and which would take account of all surfaces in the multiglazed glass element sequentially, counted from the outside inward, in FIG. 2E, FIG. 2F, FIG. 2G and FIG. 2H, would assign a “position 4” to the glass surface Pos2 and a “position 5” to the glass surface Pos3; the surfaces between the glass panes G1.1 and G1.2 of the laminate glass pane GV1 on the film F are counted as “position 2” and “position 3.”

The variants show a sequence of a coating B and an arrangement of sequins P on an inner face of one of the glass panes of the multiglazed glass vision element that faces the pane interspace. The laminated safety glass VSG here is configured like the laminate glass pane GV1 in the exemplary embodiment of FIG. 1B, image (b), to which reference is made here. Moreover, the designs of the multiglazed glass vision elements are of analogous construction to those of the multiglazed glass vision elements of FIG. 2A, FIG. 2B, FIG. 2C and FIG. 2D, and so reference is made here to the above description.

The abovementioned variants and other variants relating to the embodiments of FIG. 2A to FIG. 2D, by the embodiments of FIG. 3 to FIG. 5, are each executed analogously with glass panes as single-pane glass and are described as a triple-glazed glass vision element 10—i.e. in variants labelled 11V, 11H, 11z, 12Z—and double-glazed glass vision element 20—i.e. in variants labelled 12V, 12H—in FIG. 3 or FIG. 4 and FIG. 5. Analogously, the embodiments of FIG. 3 to FIG. 5 can be adapted with a laminated safety glass VSG, as described and shown in the variants of FIG. 2E, FIG. 2F, FIG. 2G and FIG. 2H.

It should accordingly be understood that this type of variants of embodiments is not meant to be restrictive, but can be expanded analogously, also for four, five or six etc. multiglazed glass vision elements 10, 20—the elucidation with reference to the illustrative double-glazed glass vision elements 20 and triple-glazed glass vision elements 10 should thus be understood in that sense by way of illustration in this context. Accordingly, for the sake of simplicity, the same reference symbol has been used in the present context for the same or similar features, or features of the same or similar functions.

In the embodiments shown in FIG. 3 and FIG. 5, a multitude of sequins P is disposed on the first and/or second glass pane G1, G2 to achieve a visual appearance, where the multitude of sequins P has been applied, in particular directly, on an inner face G-in of the first and/or second glass pane G1, G2 that faces the pane interspace SZR.

In other words, the sequins P have been applied on the first glass pane G1 on the glass surface Pos2 according to the embodiment of FIG. 3. In other words, the sequins P have been applied on the second glass pane G2 on the glass surface Pos3 according to the embodiment of FIG. 4.

It is likewise possible in the embodiments of FIG. 3 and FIG. 4 to apply the sequins P on both glass surfaces, i.e. on the glass surface Pos2 and on the glass surface Pos3.

It is also possible, in the case of the embodiments of FIG. 3 and FIG. 4—as shown in FIG. 2E to FIG. 2H—preferably to form the first glass pane G1 in the form of a simple laminate glass pane GV1; in other words, here specifically to apply the sequins on an inner face G-in of the glass pane labelled G1.2 in a laminate glass pane GV1 (comprising the glass panes labelled G1.1 and G1.2 and a film F according to the diagram in FIG. 1B, view (b)), of the multiglazed glass vision element.

It will be apparent that, according to the embodiments of FIG. 3 and FIG. 4—in the variant of view (a) or (b), the first glass pane G1 or the second glass pane G2-on its inner face G-in that faces the pane interspace SZR (specifically the front pane interspace SZR-V), in each case bears a functional coating B. In the case of the first glass pane G1 this corresponds to the glass surface Pos2, and in the case of the second glass pane G2 this corresponds to the glass surface Pos3. The coating B is designed in the present context for the purpose of improved sun and/or heat protection.

The sequins P, in the embodiments shown in FIG. 3 and FIG. 4—analogously according to the embodiment of FIG. 2C—are thus between a first glass pane G1 and the coating B (FIG. 3) or analogously (FIG. 4) between a second glass pane G2 and the coating B. In these embodiments, one of the glass panes G1, G2 in each case is thus free of sequins P and free of coating B.

The coating B, in an embodiment, may also be disposed directly on the glass pane G1 or G2.

Bearing that in mind, reference is further made first to FIG. 3. In the embodiment shown in FIG. 3, view (a), and in the embodiment shown in view (b) of FIG. 3, the multitude of sequins P on the first glass pane G1 has indeed been applied to the glass surface Pos2, namely directly on an inner face G-in of the first glass pane G1 that faces the pane interspace SZR. In the installed state of the multiglazed glass vision element 10, 11V or 20, 12V, the first glass pane G1 is intended as outer pane and hence faces “outward” to a building exterior. In this embodiment, the second glass pane G2 is intended as inner pane according to the variants in view (a) and view (b) and hence faces “inward” to a building interior. The building exterior is referred to in the present context as the “outside” and the building interior in the present context as the “inside.” The variant shown in view (b) is designed as a triple-glazed glass vision element—meaning that the second glass pane G2 is followed directly by a further pane interspace SZR and a third glass pane G3, kept spaced apart by the spacer structure which is otherwise unspecified here. In the embodiment of FIG. 3 shown in view (a), for formation of the multiglazed glass vision element 20, 12V as a double-glazed glass vision element, the first glass pane G1 and the second glass pane G2 are the only glass panes of the multiglazed glass vision element 20, 12V.

In the embodiment according to the aforementioned variants in view (a) and view (b), the sequins P have only been applied on the glass surface Pos2, i.e. directly on the inner face G-in of the first glass pane G1 that faces the pane interspace SZR. The other glass panes are free of sequins P.

Nevertheless, it should be understood that, in a modification of this embodiment that is not shown here, the sequins P can also be applied to the glass pane or other glass panes-in particular the second glass pane G2—in addition to the sequins P applied to the first glass pane G1.

This also becomes even clearer from the other embodiments of FIG. 4. It should already be mentioned at this point that the embodiments which follow, relating to the arrangement of the sequins P on one of the glass panes G, may be combined in this respect with the variants of the arrangement of the sequins P shown in the embodiment of FIG. 3 on the first glass pane G1. In other words, the sequins P may not only be arranged on the glass surface Pos2, but also additionally or alternatively on the glass surface Pos3 of the embodiments of the multiglazed glass vision element 10, 20 that are shown here.

Reference is now further made to FIG. 4. Accordingly, FIG. 4 shows, in view (a) and (b), the embodiment in two variants, a previously elucidated triple-glazed glass vision element 10, 11H or double-glazed glass vision element 20, 12H, in which the sequins P in each case have been directly applied on an inner face G-in of the second glass pane G2 that faces the pane interspace SZR as inner pane.

In other words, the main difference between the first embodiment of the multiglazed glass vision element 10, 11V or 20, 12V according to FIG. 3 and the second embodiment of the multiglazed glass vision element 10, 11H and 20, 12H according to FIG. 4 is that the sequins P in the first embodiment of FIG. 3 are disposed on the inner face G-in of the first glass pane G1 as outer pane (in this respect, viewed from the outside, “at the front” according to the choice of reference symbols 10, 11V, 20, 12V on the front glass pane G1—i.e. on the glass surface Pos2); whereas, in the second embodiment of FIG. 4, the sequins P have been applied on the second glass pane G2 as inner pane (double-glazed glass vision element) or as middle glass pane (triple-glazed glass vision element) on the inner face G-in thereof (i.e. on the glass surface Pos3) (in this respect “at the back” according to the choice of reference symbols 10, 11H, 20, 12H on the rear glass pane G2).

It should be understood that—as elucidated above—the sequins P may be applied not only to the front glass pane G1 or the rear glass pane G2, but also to both glass panes, i.e. the first and second glass pane G1, G2, namely the front glass pane, meaning the first glass pane G1 as outer pane, and also on the rear or middle inner pane, i.e. the second glass pane G2.

In the embodiments of a triple-glazed glass vision element 10 elucidated above, in accordance with the respective variants (b) of FIG. 3 and FIG. 4, the third glass pane G3—in the pane interspace SZR that spaces the panes apart, specifically the rear pane interspace SZR-H behind the second glass pane G2 in the triple-glazed glass vision elements 11V, 11H-is free of sequins P.

Nevertheless, it is also possible in principle for the third glass pane G3 to be provided with sequins. An embodiment that is not shown in this regard takes account of this possibility and can be combined in this respect with the embodiments elucidated above; i.e., in one modification, the sequins P may also be disposed on an inner face G-in3 of the third glass pane G3 which is assigned to the rear pane interspace SZR-H. In principle, in one modification, the sequins P may also be disposed on an inner face G-in2 of the second glass pane G2 which is assigned to the rear pane interspace SZR-H.

It will be apparent that, in the present context, according to the embodiments of FIG. 3 and FIG. 4 in the variant of view (a), the first glass pane G1 and the second glass pane G2, on their inner face G-in that faces the pane interspace SZR, each have a functional coating B which is designed in the present context for the purpose of improved sun and/or heat protection.

The sequins P—if present—in the embodiments shown in FIG. 3 and FIG. 4—analogously to the variant of FIG. 2C—are thus between a first glass pane G1 and the coating B or analogously (not shown) between a second glass pane G2 and the coating B. If, in these embodiments, one of the respective glass panes G1, G2 is free of sequins P, the coating B is disposed (or may be disposed) directly on the glass pane G1, G2.

It is also possible that the sequins P may be applied additionally or alternatively, in particular directly, on an inner face G-in of the third glass pane G3 that faces the pane interspace SZR in a triple-glazed glass vision element 10 of FIG. 3 or FIG. 4.

The interspace Z in FIG. 3 and FIG. 4 will be discussed within the scope of FIG. 5.

FIG. 5 shows, in a schematic diagram, the construction of an exemplary embodiment of a functional multiglazed glass vision element or insulation glass vision element according to the first aspect of the present disclosure.

With regard to the embodiment shown in FIG. 5, this shows an exemplary embodiment, namely in the modifications of view (a) and (b), a first triple-glazed glass vision element 10, 11Z and a second triple-glazed glass vision element 20, 12Z. Here too, the first glass pane G1 forms the outer pane; the third glass pane G3 forms the inner pane toward the interior “on the inside.” The second glass pane G2 perceptibly sits—effectively as middle pane—between the first and third glass panes G1, G3. In order to avoid repetition, reference is made in this regard to the elucidations relating to FIG. 3, view (b), and FIG. 4, view (b).

By contrast to the embodiment shown in FIG. 3, view (b), and FIG. 4, view (b), in the present case, the sequins P are not arranged together with a coating B but separately from the coating B on the first or second glass pane G1, G2. In view (a) of FIG. 5, the first glass pane G1 is free of sequins and bears the coating B, while in view (b) of FIG. 5, the second glass pane G2 is free of sequins P and bears the coating B. Accordingly, the glass panes G1, G2 only bear either a coating B-for example as sun protection and/or heat protection coating—or the sequins. The embodiment of views (a) and (b) of FIG. 5, which is designed in this regard as a triple-glazed glass vision element, differs in this respect in the arrangement of the sequins P in combination with the coating.

It may be advantageous in principle that the first and/or second glass pane G1, G2 has sequins P applied directly on its inner face G-in. It has been found to be superior and advantageous overall for either the first or else the second glass pane G1, G2 to have sequins P applied directly on its inner face G-in—this may advantageously have been implemented as in the embodiments of FIG. 2B and FIG. 5, view (a); the coating B is applied there on that side of the glass pane G1 (at the glass surface Pos2) which is opposite the side populated with sequins P (at the glass surface Pos3) of the glass pane G2. This may be implemented particularly advantageously in this aspect in the variant in the embodiments of FIG. 2A and FIG. 5, view (b); in this variant, the coating B is provided on the glass surface Pos3, i.e. on that side of the glass pane G2 which is opposite the side of the glass pane G1 populated with sequins P (at the glass surface Pos2). The sequins P can be outwardly effective here without hindrance from the coating and in this respect can be perceived in an optimized manner.

If the sequins P thus lie on the inner face G-in of the outer glass pane G1 (on the glass surface Pos2), the coating B on the outer face G-in of the inner glass pane G2 is within the SZR; the sequins P (on the glass surface Pos2) are thus then, viewed from the outside, in front of the glass coating (on the glass surface Pos3).

In the variant shown in FIG. 2B and FIG. 5, view (a), the “reverse” version is apparent, in which the coating B is on the inner face of the outer glass pane G1 (on the glass surface Pos2), but the sequins P are on the outer face of the inner glass pane G2 (on the glass surface Pos3). The sequins P are thus behind the glass coating B. If the sequins—viewed from “the outside”—are in front of the glass coating B, the spacing D between the sequins—in particular with the functional effect of a bird protection solution—may nevertheless advantageously be made greater than the spacing d when the sequins—viewed from the “outside”—are behind the coating (D>d). Accordingly, an interspace Z between the sequins P on the first glass pane G1 is greater than an interspace Z between the sequins P on the second glass pane G2.

A coating B may also be present on the third glass pane G3. If a coating B has been applied only on the inner face G-in of the first glass pane G1 (FIG. 5, view (a)), i.e. is preferably on that first glass pane G1 as outer pane, it does not have to be present on the inner face G-in of the second glass pane G2 as inner pane; it can be dispensed with there in favor of the sequins P, which can additionally be better applied directly to, and adhere better on, the inner face of the glass G-in of the second glass pane.

In a variant (FIG. 5, view (b)), however, the coating B may also only be present on the inner face G-in of the second glass pane G2; this is correspondingly advantageous and has an even more advantageous functional effect of the sequins P, since these are arranged “as seen from the outside” in front of the coating B.

In an embodiment of the present disclosure, a coating B can also be dispensed with completely.

The sequins P are thus arranged according to the variant of FIG. 5 shown in view (a) on a glass surface, labelled Pos3 here, on the second glass pane G2. In other words, in the present context, the sequins P—of a type shown in FIG. 2B—have been applied on the inner face that faces the pane interspace SZR—as the front face G-in—of the second glass pane G2, i.e. are disposed on that glass surface labelled Pos3; the sequins P are disposed directly on the inner face G-in of the second glass pane G2 that faces the front pane interspace SZR-V, leaving lateral interspaces Z, as mentioned above.

In the variant of an embodiment shown in view (b) of FIG. 5, the sequins P, by contrast, are disposed on an inner face G-in of the first glass pane G1 that faces the front pane interspace SZR-V, leaving somewhat larger interspaces Z (D>d). In this case too, the sequins P without coating B have been applied directly to this rear inner face of the first glass pane G1, i.e. in the manner as elucidated with reference to FIG. 2A.

The third glass pane G3 may—but need not, as shown in FIG. 5—nevertheless bear a coating B, although this modification is not shown in FIG. 5.

It is also possible in principle for the second glass pane G2 to bear, on its back side G-in, i.e. the inner face G-in that faces the rear pane interspace SZR-H, sequins P and/or a coating B (i.e. at Pos4, for example, analogously to the manner shown with reference to the variants in FIG. 2A to FIG. 2D for glass surface Pos2). This option is an option in principle when the first glass pane G1 formed as outer pane on glass surface Pos2 and the second glass pane G2 formed as inner pane on glass surface Pos3 should not bear a coating B or sequins P.

In all the above-detailed embodiments of FIG. 3 to FIG. 5, a spacer structure A is provided that keeps the panes G spaced apart. The spacer structure A is formed in these embodiments thus detailed as a peripheral frame AR, by means of which the first and second glass panes G1, G2—and optionally the third glass pane G3, usually in the views (a)—are framed and hence kept spaced apart.

A corresponding pane interspace SZR, SZR-V, SZR-H is referred to here in the present context as the entire pane interspace SZR, this meaning that, in the case of a third glass pane G3, the pane interspace SZR has a front pane interspace SZR-V adjacent to the first and second glass panes G1, G2 and a rear pane interspace SZR-H adjacent to the second and third glass panes G2, G3. There is then effectively an outer pane interspace SZR-V between outer pane (first glass pane G1) and second glass pane G2 and an inner pane interspace SZR-H between inner pane (second glass pane G2) and third glass pane G3.

The intrinsically customary framing AR of the glass panes G1, G2 and optionally G3 has been found to be useful, in particular for formation of a multiglazed insulation glass vision element in which the pane interspace SZR that spaces the panes apart is free of air. In particular, a pane interspace SZR for forming an insulation glass vision element can be filled with insulating gas, for example argon or krypton, or can simply be left free of air. For further isolation, the frame AR can be sealed airtight with butyl.

If the pane interspace SZR is free of air, it has been found to be particularly preferable to vacuum this pane interspace—i.e. optionally including an outer and inner pane interspace SZRV, SZRH. What is meant by “vacuumed” is evacuated or intended for evacuation. Several options have been found to be useful here—for example, a pane interspace SZR can be vacuumed on the part of the manufacturer or be provided with a valve, for example via the first and/or second glass pane G1, G2 and optionally third glass pane G3, in order to vacuum it retrospectively.

In this aforementioned case, it has been found to be useful for a spacer structure A in the form of one or more spacer elements to be disposed in the pane interspace that spaces the panes apart, i.e. in the viewing region of the pane.

The spacer structure A may have been formed from mostly small spacer elements of about one millimeter in size or smaller. These would only be discernible at a viewing distance of 1 m to 2 m. Individual support elements or a multitude thereof are generally referred to hereinafter as spacer elements AH. These spacer elements AH may be distributed in a grid over the pane interspace.

In an embodiment shown in FIG. 6, such a spacer element AH is in the form or shape of a sequin P. The multitude of sequins P can thus be utilized as a multitude of spacer elements AH and form the novel spacer structure A between a first and second glass pane G1, G2 in a pane interspace SZR, as shown in FIG. 6.

The pane interspace SZR can thus be reliably vacuumed, while sequins P as spacer elements AH keep the first glass pane G1 and G2 spaced apart; the first glass pane G1 formed as outer pane and the second glass pane G2 formed as inner pane can thus not be collapsed even by an elevated vacuum in the pane interspace SZR, since the sequins P are formed as spacer elements.

FIG. 6A and FIG. 6B show, in a schematic diagram, a construction of an embodiment of a functional multiglazed glass vision element or insulation glass vision element according to the first aspect of the present disclosure with single-pane glass in FIG. 6A and with laminated safety glass VSG in FIG. 6B.

In this regard, a schematic diagram shows the structure of an embodiment of a functional multiglazed glass vision element or insulation glass vision element 10, 12W according to the first aspect of the present disclosure, which is described below. The coating B shown therein on the inner face of the first and second glass panes G1, G2 can also advantageously be dispensed with on one or both of the first and second glass panes G1, G2.

In the embodiments shown in FIG. 6A and FIG. 6B, the sequins P are designed to improve their spacer effect as optimized spacer elements P and are of a flat design for that purpose.

However, they could also be domed; domed sequins can offer certain benefits in terms of their optical effect and the spacer function. The sequins P are accordingly—in an embodiment not shown here-formed as domed sequins P_{w} possible or—as shown here—flat in the present context, i.e. largely planar or at least flat. A flat sequin P in particular with a thickness of more than 100 μm (micrometers) would already be sufficient to fulfill the intended spacer function.

In the case of a domed sequin P_{w}, a variable mode of curvature in a sequin Pw would be possible in principle if required, in order to exert an effect of a spacer element AH. The curvature may be formed as desired—for example as an S shape or U shape—which can conform to the radius or circumference of the sequin P.

It is advantageous that with such a spherical or different curvature of a sequin P_{w} on its reflective side, “outward” visibility of the sequin P_{w} from the outside can also be optimized.

A multiglazed glass vision element 10, 12W shown in FIG. 6A and FIG. 6B is formed in this respect as a double-glazed glass vision element, namely as a vacuum insulation glass vision element, with a vacuum in the pane interspace SZR and hence improved insulation properties owing to the vacuumed pane interspace SZR.

In addition, the double-glazed glass vision element 10, 12W is of comparatively thin design by comparison with the double-glazed glass vision elements 10, 12H, 12, 12V.

Domed sequins P_{w} or—as in the present context—flat or largely flat sequins P have the advantage that even their lateral extent is comparatively small; a grid of sequins P with diameters in the range of 3-12 mm for formation of corresponding contacts W and spacings Z in the pane interspace SZR of the order of magnitude d or D with a grid in the spacing range of 50-120 mm will firstly already be sufficient to be “dense” enough to fulfill visual functionality for the purpose of bird protection (i.e. to be recognized by a bird) and secondly be sufficiently “contact-reduced” to fulfill the insulation properties which between the panes kept spaced apart (the first and second panes G1, G2, optionally the third pane G3).

If the sequins P_{w} are domed, this can be advantageously be utilized to optimize their “outward” reflective properties with respect to the exterior and at the same time to optimize their effect as spacer element AH, in order to maintain the spacing in the viewing region of the glass panes G1, G2 as well and to minimize thermal conduction effects owing to reduced contacts W with the curvature; i.e. improved isolation with optimized bird protection properties.

The functional multiglazed glass vision element or insulation glass vision element 10, 12W of FIG. 6A provided with single-pane glass ESG for formation of the first and second glass panes G1, G2.

The functional multiglazed glass vision element or insulation glass vision element 10, 12W of FIG. 6B has been provided with laminated safety glass VSG for formation of the first glass pane G1 as laminate glass pane GV1. In embodiments of the present disclosure, the second glass pane G1 is formed as a laminate glass pane.

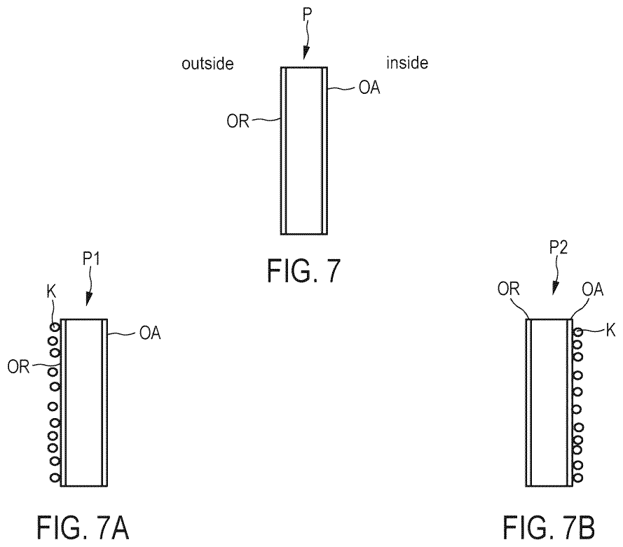

FIG. 7 shows the basic construction of sequins P according to an embodiment of the present disclosure. A sequin P has a light-absorbing surface OA and a light-reflecting surface OR on a carrier or as part of the carrier; in particular, the carrier T may form the light-absorbing surface OA and be coated with a metallic or metal oxide reflective coating to form the light-reflecting surface OR. It is preferable that a layer structure can be designed with one or more visually semitransparent layers of metal oxides for the light-reflecting surface OR of the sequin, which in particular in a broader sense has metallic or metal oxide reflectivity.

It is particularly advantageous that the light-reflecting surface OR, in particular having metallic or metal oxide reflectivity, of a sequin has a semitransparent layer having significantly elevated reflectance R_{non-VIS} in the nonvisible spectral region (non-VIS) compared to a reflectance R_{VIS} in the visible spectral region (VIS), and/or—significantly lowered transmittance T_{non-VIS} in the nonvisible spectral region (non-VIS) compared to a transmittance T_{VIS} in the visible spectral region (VIS).

This has the advantage that a reflection of a sequin which is particularly readily perceptible to birds outside the visible spectral region (non-VIS) is thus amplified with particularly high efficiency (owing to R_{non-VIS}).

For example, a semitransparent surface of a sequin—i.e. the light-reflecting surface OR of the sequin that in particular has metallic or metal oxide reflectivity—with about 80% transmittance T_{VIS} and 20% reflectance R_{VIS} in the visible region VIS can be designed with a construction composed of various visually semitransparent layers, in particular metallically reflective layers.

It is preferably possible to design a layer structure with one or more visually semitransparent layers of metal oxides for the light-reflecting surface OR of the sequin, which in particular in a broader sense has metallic or metal oxide reflectivity; it can be designed in such a way that the layer structure has significantly elevated reflectance R_{non-VIS} in the nonvisible spectral region (non-VIS) compared to a reflectance R_{VIS} in the visible spectral region (VIS), and/or has significantly lowered transmittance T_{non-VIS} in the nonvisible spectral region (non-VIS) compared to a transmittance T_{VIS} in the visible spectral region (VIS).

In other words, a layer structure having one or more visually semitransparent layers, in particular composed of different metal oxides (thus in a broader sense of metallic or metal oxide reflectivity), may be formed in such a way that the ratio R_{non-VIS}/T_{non-VIS} of transmission T_{non-VIS} and reflection R_{non-VIS} is significantly altered, in particular increased, in a region nonvisible to the human eye (non-VIS), compared to a ratio R_{VIS}/T_{VIS} of transmission T_{VIS} and reflection R_{VIS} in a region visible to the human eye (VIS). The elevated reflection relative to the visible spectral region (VIS) in the nonvisible spectral region (non-VIS) can be formulated in a formula as:

R_{non-VIS—/}T_{non-VIS}>R_{VIS}/T_{VIS}

It should be understood that the nonvisible spectral region (non-VIS) may preferably include the UV region and/or the IR region—i.e. may include an ultraviolet spectral region alone or in combination with an infrared spectral region. It may be the case that an effect can be achieved even when the “edges” of the visible spectral region (VIS) in relation to the nonvisible spectral region (non-VIS) are designed in this way. This means that a reflection of the sequin in terms of an overall effect perceptible by the bird's eye is again distinctly increased and hence the efficacy of the sequin in the intended visibility (for birds) is enhanced.

It may additionally be the case—likewise advantageously—that the overall perception of the sequin in terms of its effect on the human eye is attenuated compared to the overall effect perceptible by the bird's eye.

In any case, the perceptibility of the reflective layer of the sequin by the bird's eye on the one hand and the human eye on the other hand can be designed independently from the outset via the design of the layer structure mentioned with one or more visually semitransparent layers for the light-reflecting, in particular metallically reflecting, surface OR of a sequin.

The sequins that thus reflect primarily in the nonvisible region (non-VIS) in particular are then perceived by the birds-if not as individual sequins, then the arrangement of the sequins—on the glass pane as an obstacle. It should then advantageously not be a problem for the human eye if the coverage is distinctly higher than specified above. The reason is that such a sequin is then comparatively invisible to the human eye in the above sense, but particularly distinctly visible by a bird. A film thickness of the visually semitransparent layer for the light-reflecting, in particular metallically reflecting, surface OR of a sequin could be at least 25 μm (micrometers) here.

The light-reflecting surface of the sequin may be formed as a metallically reflective surface OR may also—additionally or alternatively—with a coating of aluminum or copper or similar nonferrous metal. In the installed state of the multiglazed glass vision element, the light-absorbing surface OA should be intended to face a building interior and the light-reflecting surface OR should be intended to face a building exterior.

FIG. 7A shows a sequin P1 prepared properly for application for a multiglazed glass vision element of FIG. 2, and FIG. 7B a sequin P2 properly prepared for application for a multiglazed glass vision element of FIG. 3.

An adhesive K is used for the sequin P1 of FIG. 7A on the light-reflecting surface OR for adhesive application in contact with the inner face G-in of the first glass pane G1 that faces a pane interspace SZR; i.e. to form an adhesive layer between the inner face G-in of the first glass pane G1 and the light-reflecting surface OR of the sequin P1.

An adhesive K is used for the sequin P2 of FIG. 7B on the first light-absorbing surface OA for adhesive application in contact with the inner face G-in of the second glass pane G2 that faces a pane interspace SZR; i.e. to form an adhesive layer between the inner face G-in of the second glass pane G2 and the first light-absorbing surface OA of the sequin P2.

It is likely to be the case that the metallically reflective sequins are advantageously applied directly to glass on the glass surface Pos3 by gluing. In this exemplary embodiment, it is remarkable that the application is not to the glass surface Pos2 which is coated with a coating B, and this is therefore an achievement of the present disclosure.

The glass surface Pos2 is advantageously covered with sequins P2. This means that the sequins P in front of the reflective coating ensure higher visibility for birds and hence the spacing chosen between the individual sequins can be greater.

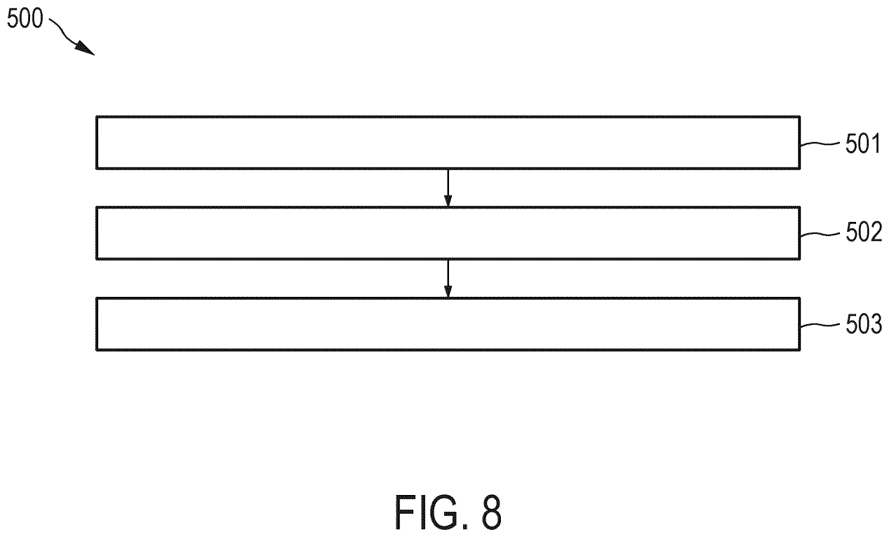

FIG. 8 shows a flow diagram for a preferred exemplary embodiment of a production process for producing a multiglazed glass vision element 10, 20 or similar multiglazed glass vision elements inter alia, as described and/or shown in the context of the present disclosure. In particular, the production process is elucidated by way of example with reference to a multiglazed glass vision element as shown in one of the exemplary embodiments of FIG. 2A to FIG. 2H, or FIG. 3, FIG. 4, or FIG. 5 or FIG. 6A, FIG. B.

The production process 500, according to this flow diagram, has at least the following steps for an exemplary embodiment:
in step 501, a first and a second glass pane G1, G2 are provided;
in step 502, a multitude of sequins P is disposed on one of the glass panes G1, G2, to achieve a visual appearance E.

For the exemplary embodiment of FIG. 2A, FIG. 2E, for example, it can be assumed that the sequins P are applied on the first glass pane G1 directly on the inner face of the glass G-in. For the exemplary embodiment of FIG. 2B, FIG. 2F, for example, it can be assumed that the sequins P are applied on the second glass pane G2 directly on the inner face of the glass G-in.

A sequin P here has a light-absorbing surface OA and a light-reflecting surface OR.

In the installed state of the multiglazed glass vision element, the light-absorbing surface OA faces a building interior (“inside”), and the light-reflecting surface OR faces a building exterior (“outside”). The sequins P here are spaced apart from one another in such a way that the multiglazed glass vision element appears transparent when viewed from the side of the light-absorbing surface OA of the sequins P and appears less transparent when viewed from the side of the light-reflecting surface OR of the sequins P.

For the functional effect of a bird protection element, it has been found to be advantageous that, in step 502, the multitude of sequins is in such a spaced-apart arrangement that they are perceptible by and have the effect of scaring off a bird.

In other words, for formation of a bird protection grid, an area coverage as a ratio of the total area of the multitude of sequins per unit area of the multiglazed glass vision element is established and is less than 5%, in particular less than 3%, in particular less than 2%, in particular less than 1%, in particular less than 0.5%.

It is found that highly effective bird protection is already achieved even with a relatively open grid—such as a 9/70 mm grid (i.e. sequins with diameter 9 mm on the vertices of a square dot pattern with edge length 70 mm) and correspondingly lower coverage (of at least below 2%—the given example of a 9/70 mm grid enables effective bird protection possible with only a coverage of 1.25%). It is found that highly effective bird protection is also already achieved even with a very open grid—such as a 9/90 mm grid (i.e. sequins with diameter 9 mm on the vertices of a square dot pattern with edge length 90 mm) and correspondingly even lower coverage (of at least below 1%—the given example of a 9/90 mm grid enables effective bird protection with only a coverage of 0.8% or below).

In the case of arrangement of the multitude of sequins, in step 502, a sequin P is applied directly, in particular for example for the exemplary embodiment of FIG. 2A, FIG. 2E, on an inner face G-in of the glass pane G1 that faces the pane interspace. In the case of arrangement of the multitude of sequins, in step 502, a sequin P can alternatively (or additionally) be applied directly, in particular for example for the exemplary embodiment of FIG. 2B, FIG. 2F, on an inner face G-in of the glass pane G2 that faces the pane interspace.

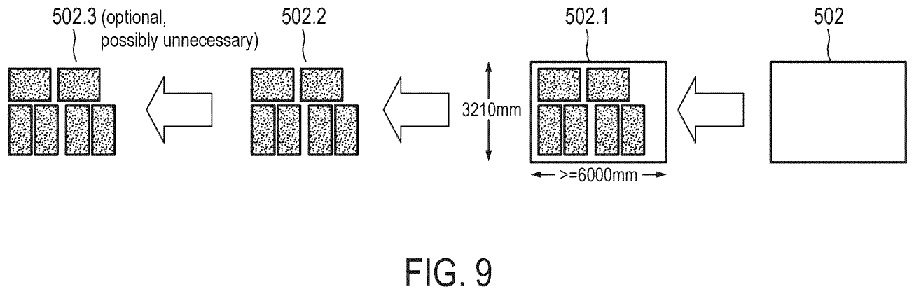

With regard to the illustration of illustrative embodiments for a visual appearance E of the functional multiglazed glass vision elements or insulation glass vision elements elucidated here, reference is made to WO 2019/038288 A1, the content of which is hereby incorporated into the content of the present application by reference-in particular with regard to the diagrams of FIG. 8 and FIG. 9A, FIG. 9B, FIG. 9C, FIG. 9D and FIG. 10 of WO 2019/038288 A1 that are shown in WO 2019/038288 A1 and the associated description in WO 2019/038288 A1.

FIG. 8 of WO 2019/038288 A1 in this regard shows an example of a uniform visual appearance E.

FIG. 9A, FIG. 9B, FIG. 9C, FIG. 9D of WO 2019/038288 A1 in this regard show an example of a facade in which, with achievement of an adjusted visual appearance E, the sequins of the multitude of sequins have different size dimensions and/or are in an irregular arrangement.

FIG. 10 of WO 2019/038288 A1 shows an example of a facade in this regard.

In step 503, the glass pane that has been populated with sequins P—for example for the exemplary embodiment of FIG. 2A, FIG. 2E—is used as a first glass pane G1 or—for example for the exemplary embodiment of FIG. 2B, FIG. 2F—as a second glass pane G2, for formation of an above-elucidated multiglazed glass vision element 10, 20.

The multiglazed glass vision element 10, 20 may take the form of a double-glazed glass vision element, wherein the first glass pane G1 and the second glass pane G2 are the only glass panes of the multiglazed glass vision element. The multiglazed glass vision element 10, 20 may—for example according to one of the variants in the views (b) of FIG. 3 and FIG. 4—take the form of a triple-glazed glass vision element which, in addition to the first glass pane G1 and second glass pane G2, has a third glass pane G3, where the third glass pane G3 is intended to face a building interior (“inside”) as inner pane.

In the preferred multiglazed glass vision element 10, 20, the multitude of sequins P has accordingly been applied, in particular directly, on the inner face G-in of the first or second pane G1, G2 that faces the pane interspace SZR.

The glass pane mentioned is preferably used—for example for the exemplary embodiment of FIG. 2A, FIG. 2E—as the first glass pane G1; or alternatively as the case may be—for example for the exemplary embodiment of FIG. 2B, FIG. 2F—as the second glass pane G2.

The glass pane mentioned that has been populated with sequins P preferably takes the form of a simple single-pane glass; i.e. preferably takes the form of an unannealed single-pane glass, in particular simple float glass. This is shown in one of the embodiments in FIG. 2A to FIG. 2D or FIG. 3, FIG. 4 or FIG. 5 or FIG. 6A.

The glass pane mentioned that has been populated with sequins P may alternatively also be as a laminate glass produced from float glass panes, as illustrated in one of the embodiments in FIG. 2E to FIG. 2H or FIG. 6B. In one modification, the laminate glass may also be formed as a laminated safety glass (VSG).

Overall, the multiglazed glass vision element 10, 20 may preferably be assembled as a vacuum insulation glass (VIG), wherein a spacer structure A is formed as a peripheral frame A, AR, AH for the first and second glass panes G1, G2 (and optionally also the third glass pane G3), by means of which the first and second glass panes G1, G2 (and optionally also the third glass pane G3) are framed in a spaced-apart manner. For this purpose, the pane interspace SZR that spaces apart the first and second glass panes, and optionally also the further pane interspace that spaces apart the second glass pane and third glass pane, may be air-free for formation of the multiglazed glass vision element as a multiglazed insulation glass vision element (VIG). The pane interspace SZR may also be filled with insulating gas, in particular argon or krypton, or be air-free, and in particular be vacuumed.

Thereafter, the multiglazed glass vision element 10, 20 is used in an installed state in a facade or in an interior configuration of a building space.

FIG. 9 shows, for step 502 in which a multitude of sequins is disposed on the glass pane to achieve a visual appearance E, that this step 502 is preferably still implemented in the float glass plant.

In the float glass plant, float glass is produced with a regularly standardized strip dimensions of width 3210 mm and typically up to 6000 mm—but possibly even more, especially up to 20 m. There is preferably also a glass coating operation and glass lamination operation in strip measurement format in the float glass plant as part of the production plant; this may apply to single-pane glass without coating or single-pane glass with coating, to laminate glass, possibly including laminated safety glass (VSG), without coating or laminate glass, possibly including laminated safety glass (VSG), with coating—always preferably in strip measurement format, of 6000 mm×3210 mm; this results in maximum utilization of the float glass system, since the float glass is still processed as a whole.

Embodiments of the present disclosure have the advantage that the application of the sequins P in step 502 can still be implemented in the float glass plant. This means that, according to embodiments of the present disclosure, many steps are also still implementable in the float glass plant—i.e. using large formats. The exemplary embodiments of FIG. 2A, FIG. 2B, FIG. 2C, FIG. 2D disclose, in the present disclosure, multiglazed glass vision elements only with a nontempered float glass pane. This means that, in the float glass plant, the simple single-pane glass/flat glass used is populated with sequins and the only step thereafter is that the glass is merely cut to size—preferably still in the factory.

Tempered single-pane safety glass, on the other hand, requires that the glass pane be populated with sequins only in the glass plant; in other words, in a smaller format than the strip measurement format in the float glass plant.

In an embodiment of the present disclosure at least the first glass pane G1 and the second glass pane G2, in particular optionally a third glass pane G3, takes the form of an unannealed single-pane glass, in particular simple float glass, or—at least the first glass pane G1 takes the form of a laminate glass with unannealed single-pane glass, in particular simple float glass, and the second glass pane G2, and in particular optionally a third glass pane G3, that of an unannealed single-pane glass, in particular simple float glass.

The product according to embodiments of the present disclosure thus consists of unannealed single-pane glass, in particular simple float glass.

This also applies in the case of laminate glass, since this is formed with unannealed single-pane glass, in particular simple float glass; for example as shown in the exemplary embodiments of FIG. 2E, FIG. 2F, FIG. 2G, FIG. 2H.

Laminated glass made from nontempered glasses can be populated with sequins in the float glass plant; the glass is merely cut to size in the plant.

Laminated safety glass made from semitempered glass panes, on the other hand, requires cutting, annealing, laminating and applying of the sequins exclusively in the glass plant.

The sequins P can thus preferably be applied, in an embodiment of the present disclosure, directly on the simple float glass in the float glass plant. Further steps such as coating and laminating to form laminate glass can also be effected in the float glass plant.

A simple float glass pane does not meet the safety requirements on a single-pane safety glass (ESG), but is nevertheless of predominant interest.

A single-pane safety glass (ESG) always comprises a tempered or annealed glass pane; accordingly, the sequins P—owing to high temperatures in the course of annealing/tempering—can only be applied thereafter. A laminated safety glass may be produced from semitempered glass panes (TVG), and also from float glass panes. Both variants correspond to a laminated safety glass (VSG).

According to embodiments of the present disclosure, the multiglazed glass vision element is thus preferably produced from float glass panes, i.e. as single glass panes (not ESG) or from laminate glass panes made from float glass panes. This means that glass populated with sequins P can be used in the float glass plant in strip measurement format.

Only after step 502—in which a multitude of sequins P is applied to the glass pane to achieve a visual appearance E—is cutting-to-size to smaller dimensions then possible in step 502.1 (shown symbolically), and in step 502.2 a more detailed glass processing operation (such as edge processing, hole drilling, or the like).

In addition, a step 502.3 with particularly energy-intensive operations such as tempering, solid mass coating and/or glass lamination at fixed dimensions is optional; i.e. only required where necessary.

In principle, even after step 502.2—without energy-intensive operations in step 502.3—in step 503 elucidated above, the glass pane can be used as first glass pane G1 or as second glass pane G2 for formation of an above-elucidated multiglazed glass vision element 10, 20.

In the production process according to embodiments of the present disclosure, it is thus firstly possible, particularly advantageously, before cutting-to-size to smaller dimensions—i.e. in particular even before transport to the glass processors and cutting-to-size to smaller dimensions in step 502.1—in any case for the applying in step 502 to be effected still within the float glass plant in strip measurement format; there may optionally also be coating in strip measurement format in the float glass plant. This optimally exploits the capacity of the float glass systems in the production of the multiglazed glass vision element 10, 20.

This is because the energy requirement per m2 of glass area increases with the number of processing steps on the individual, project-specific glass pane (lamination, solid coating) compared to strip measurement processing (>=6000×3210 mm) in the float glass plant.

Embodiments of the present disclosure, on the other hand, enables maximum processing in the float glass plant and thus reduces processing on the part of the glass processor.

In particular, there is furthermore no need for energy-intensive processes on the part of the glass processor, such as annealing or similar additional process steps, which are necessary in screen printing applications on glass; it may be possible to dispense with energy-intensive runs of step 502.3.

If, for example, tempered single-pane safety glass (ESG) or semitempered glass (TVG) should be used as part of a laminated safety glass (VSG), the application of the sequins can only be carried out in the glass plant in each case and after the energy-intensive tempering process and, in the case of laminate glass panes, the less energy-optimized lamination process compared to the lamination process in the float glass plant.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Pos1, Pos2, Pos3, Pos4, Pos5, Pos6 glass surfaces
1A, 1B, 2A, 2B multiglazed glass element
1C, 2C arrangement
10, 11V, 11H, 11z, 12Z triple-glazed glass vision element
20, 12H, 12V double-glazed glass vision element
G1, G2, G3 first, second, third glass pane
GV1 laminate glass pane
GVS glass composite vision element,
VSG laminated safety glass
VIG vacuum insulation glass
S, F composite structure film, film or composite film
SZR pane interspace
SZR-V, SZR-H first or front pane interspace, further or rear pane interspace
B coating
P sequin
P1, P2 sequin with adhesive
K adhesive
G-in the inner face/inside of the first or second glass pane G1, G2 that faces the pane interspace SZR or front pane interspace SZR-V
G-in2, G-in3 the inner face/inside of the second glass pane G2 or third glass pane G3 that faces the rear pane interspace SZR-H
A, AH, AR spacer structure, spacer elements, frame
OR, OA light-reflecting surface, light-absorbing surface

1. A multiglazed glass vision element comprising:
at least a first glass pane and a second glass pane and at least one pane interspace between the first glass pane and the second glass pane that spaces them apart, wherein at least the first glass pane and the second glass pane with the at least one pane interspace are kept spaced apart by a spacer structure,
wherein
a multitude of sequins are arranged in the multiglazed glass vision element to achieve a visual appearance
a sequin of the multitude of sequins has a light-absorbing surface and a light-reflecting surface, and in an installed state of the multiglazed glass vision element, the light-absorbing surface being intended to face a building interior and the light-reflecting surface being intended to face a building exterior,
the multitude of sequins are spaced apart from one another in such a way that the multiglazed glass vision element appears transparent when viewed from a side of the light-absorbing surface of the sequins and appears less transparent when viewed from a side of the light-reflecting surface of the sequins, and
the multitude of sequins have been applied on an inner face of one of the glass panes of the multiglazed glass vision element that faces the pane interspace.

2. The multiglazed glass vision element as claimed in claim 1, wherein the glass panes of the multiglazed glass vision element comprise of unannealed single-pane glass.

3. The multiglazed glass vision element as claimed in claim 1, wherein
the multitude of sequins is applied directly on the inner face of one of the glass panes that faces the pane interspace, or
the multitude of sequins is applied directly on a coating of the inner face of one of the glass panes that faces the pane interspace.

4. The multiglazed glass vision element as claimed in claim 1, wherein the multitude of sequins are applied exclusively on the inner face of the first and/or second glass pane that faces the pane interspace.

5. The multiglazed glass vision element as claimed in claim 1, wherein
in the installed state of the multiglazed glass vision element, the first glass pane is intended to face the building exterior as an outer pane and the second glass pane is intended to face the building interior as an inner pane, wherein the multiglazed glass vision element comprises a double-glazed glass vision element, wherein the first glass pane and the second glass pane are sole glass panes of the multiglazed glass vision element.

6. The multiglazed glass vision element as claimed in claim 1, wherein the multiglazed glass vision element comprises a triple-glazed glass vision element, wherein the multiglazed glass vision element further comprises
a third glass pane, wherein the first glass pane and the second glass pane and the third glass pane are sole glass panes of the multiglazed glass vision element; and
a further pane interspace between the second glass pane and the third glass pane that spaces them apart, wherein the second glass pane and the third glass pane with the intervening further pane interspace are kept spaced apart by the spacer structure or another spacer structure, wherein
the first glass pane is intended to face the building exterior as an outer pane and the second glass pane is provided between the first and third glass panes, and the third glass pane is intended to face the building interior as an inner pane.

7. The multiglazed glass vision element as claimed in claim 1, wherein the spacer structure for the first and second glass panes comprises a peripheral frame for keeping the first and second glass panes framed in a spaced-apart manner.

8. The multiglazed glass vision element as claimed in claim 1, wherein
the at least one pane interspace that spaces apart the first and second glass panes is air-free for forming the multiglazed glass vision element as a multiglazed insulation glass vision element.

9. The multiglazed glass vision element as claimed in claim 8, wherein
the at least one pane interspace is filled with insulating gas, or
the at least one pane interspace is provided with a vacuum for insulation of the multiglazed glass vision element and formation as a multiglazed vacuum insulation glass vision element.

10. The multiglazed glass vision element as claimed in claim 1, wherein the first and the second glass panes are kept spaced apart by the spacer structure that comprises one or more spacer elements in the at least one pane interspace in a viewing region of the pane.

11. The multiglazed glass vision element as claimed in claim 1, wherein the spacer structure is formed by one or more of the multitude of sequins on the first and/or second glass panes, wherein at least one or more of the multitude of sequins are formed as a spacer element.

12. The multiglazed glass vision element as claimed in claim 11, wherein a sequin for formation of the spacer element is flat and the sequin has a height that extends across the at least one pane interspace.

13. The multiglazed glass vision element as claimed in claim 1, wherein
a sequin has been applied on the inner face of the first and/or second glass pane that faces the at least one pane interspace via an adhesive or bonding agent.

14. The multiglazed glass vision element as claimed in claim 1, wherein the light-reflecting surface of a sequin has metallic or metal oxide reflectivity, and/or wherein the light-absorbing surface of a sequin is black.

15. The multiglazed glass vision element as claimed in claim 1, wherein a sequin is flat or domed and/or has a layer structure comprising a decorative film and a light-absorbing layer.

16. The multiglazed glass vision element as claimed in claim 1, wherein a sequin has been applied on a glass surface or directly on a coating of the glass surface, on the inner face of the first glass pane that faces the at least one pane interspace, the first glass pane being intended to face the building exterior as an outer pane, wherein
a second light-reflecting surface of the sequin has been applied on the glass surface or directly on the coating of the glass surface on which the inner face of the first glass pane that faces the at least one pane interspace has been applied.

17. The multiglazed glass vision element as claimed in claim 1, wherein a sequin has been applied on the inner face of the second glass pane that faces the at least one pane interspace, the second glass pane being intended to face the building interior as an inner pane, wherein
the light-absorbing surface of the sequin has been applied in on the inner face of the second glass pane that faces the at least one pane interspace, wherein the light-absorbing surface of the sequin bears an adhesive.

18. The multiglazed glass vision element as claimed in claim 16, wherein the inner face facing the at least one pane interspace in that glass pane which is opposite the glass pane populated with sequins has a glass coating.

19. The multiglazed glass vision element as claimed in claim 1, wherein
a sequin has been applied directly on the inner face of the first or second glass pane that faces the at least one pane interspace, without a coating between the glass pane and the sequin, or
a sequin has been applied on the inner face of the first or second glass pane that faces the at least one pane interspace, on the coating between the glass pane and the sequin, or
a sequin has been applied on the inner face of one of the first glass pane and the second glass pane that faces the at least one pane interspace, wherein the sequin is in contact with the first glass pane and the second glass pane.

20. The multiglazed glass vision element as claimed in claim 1, wherein an arrangement of the multitude of sequins on the first and/or second glass pane achieves a visual appearance, wherein
the sequins on the first glass pane as an outer pane are at a first lateral spacing from one another, and/or
the sequins on the second glass pane as an inner pane are at a second lateral spacing from one another, wherein
the second lateral spacing on the second glass pane is less than the first lateral spacing.

21. The multiglazed glass vision element as claimed in claim 1, wherein the sequins are formed and/or spaced apart from one another so as to form a functional grid for configuration of a functional visual function and/or protective function of the multiglazed glass vision element against an external action, wherein the external action is selected from the group consisting of: bird protection, sun protection, and/or heat protection.

22. The multiglazed glass vision element as claimed in claim 1, wherein a bird protection grid is formed in that an area coverage as a ratio of a total area of the multitude of sequins per unit area of the multiglazed glass vision element is less than 5%.

23. The multiglazed glass vision element as claimed in claim 1, wherein the light-reflecting surface has
significantly elevated reflectance in the nonvisible spectral region compared to a reflectance in the visible spectral region and/or
significantly lowered transmittance in the nonvisible spectral region compared to a transmittance in the visible spectral region.

24. A window element and/or facade element for an installed state in a facade or in an interior configuration of a building space comprising a multiglazed glass vision element as claimed in claim 1.

25. A method of production for a multiglazed glass vision element comprising the steps of:
providing a first and a second glass pane;
arranging a multitude of sequins on the first glass pane and/or second glass pane to achieve a visual appearance, wherein
a sequin of the multitude of sequins has a light-absorbing surface and a light-reflecting surface, and in an installed state of the multiglazed glass vision element, the light-absorbing surface is intended to face a building interior and the light-reflecting surface is intended to face a building exterior, and
the multitude of sequins are spaced apart from one another in such a way that the multiglazed glass vision element appears transparent when viewed from a side of the light-absorbing surface of the sequins and appears less transparent when viewed from a side of the light-reflecting surface of the sequins, wherein
the multitude of sequins are applied on an inner face of one of the glass panes of the multiglazed glass vision element that faces the pane interspace.

26. The production method as claimed in claim 25, wherein the arrangement of a multitude of sequins on the first glass pane and/or second glass pane to achieve the visual appearance precedes cutting-to-size and/or to a strip measurement format in a float glass plant.

27. (canceled)
